(19) United States
(12) Patent Application Publication
(10) Pub. No.: US 2026/0312812 A1
(43) Pub. Date: Oct. 8, 2026

(54) ARTICLES AND METHODS FOR AUTOMATED PARALLELIZATION OF ZERO KNOWLEDGE PROTOCOLS

(71) Applicants: Yale University, New Haven, CT (US); Northwestern University, Evanston, IL (US)

(72) Inventors: Yuyang Sang, New Haven, CT (US); Xiao Wang, Evanston, IL (US); Timos Antonopoulos, New Haven, CT (US); Ruzica Piskac, New Haven, CT (US); Ning Luo, Evanston, IL (US)

(21) Appl. No.: 19/478,568

(22) PCT Filed: Apr. 24, 2024
(86) PCT No.: PCT/US2024/026025

§ 371 Date: Oct. 24, 2025

Related U.S. Application Data
(60) Provisional application No. 63/498,230, filed on Apr. 25, 2023.

(51) Int. Cl. H04L 9/32

(52) U.S. Cl. CPC H04L 9/3218; H04L 2209/08; H04L 2209/125

(57) ABSTRACT

Provided herein are a method of parallelizing zero-knowledge (ZK) protocols, an apparatus for parallelizing zero-knowledge (ZK) protocols, and an apparatus for proving zero-knowledge (ZK) protocols. The method includes providing a ZK framework; calculating local and communication costs for each program instruction of a ZK statement; automatically partitioning the ZK statement according to the calculation; and distributing the partitioned ZK statement to a corresponding number of computing cores for parallel proving or verification. The apparatus for parallelizing zero-knowledge (ZK) protocols includes a processor and a memory unit configured to implement the method. The apparatus for proving zero-knowledge (ZK) protocols includes at least two processors, a memory unit, a communication interface, and a ZK statement parallelized according to the method distributed among the at least two processors. Also provided herein is a non-transitory computer readable storage medium storing computer-executable instructions for performing the method.

### CROSS-REFERENCE TO RELATED APPLICATIONS

The present application claims priority under 35 U S.C. § 119(e) to U.S. Provisional Patent Application No. 63/498,230, filed Apr. 25, 2023, which application is incorporated herein by reference in its entirety.

### STATEMENT REGARDING FEDERALLY SPONSORED RESEARCH OR DEVELOPMENT

This invention was made with government support under CCF-2106845, CCF-2131476, CCF-1763399, 2016240, and 2236819 awarded by National Science Foundation (NSF) and HRO002230C0087 awarded by Defense Advanced Research Projects Agency (DARPA). The government has certain rights in the invention.

### BACKGROUND OF THE INVENTION

Zero-knowledge proofs (ZKPs) enable a prover to convince a verifier about the truth of some statement without revealing why. Recent advances by the cryptographic research community have brought a tremendous improvement in the efficiency of general-purpose zero-knowledge (ZK) proving, as well as numerous creative applications of ZKPs. Despite this progress, there are still significant challenges that prevent the widespread adoption of ZKP in real-world scenarios.

For example, when applying ZKPs to new problems, a major challenge is to describe the statement to be proven in a way that is both natural for programmers and suitable for compilation. Most ZK languages and compilers currently available only support the circuit model, which relies on data-oblivious computation and requires that control flow be independent of all private variables. However, this model doesn't fully capture the flexibility and power of modern ZKP constructions. For instance, non-determinism can accelerate many statements where the prover provides extra hints to the computation. Other statements, such as 3-coloring and Haimiltonian cycles in graphs, can be verified with high efficiency under a probabilistic guarantee, where the verifier provides extra random challenges and the prover replies with challenge-dependent hints. Unfortunately, there's currently no general-purpose ZK programming framework that can support proofs across multiple computational models.

Another practical challenge of ZKP is the demand for massive hardware resources, which limits scaling ZKPs to large statements and creates bottlenecks in computation and communication resources. To address this, recent research has explored “scaling out” ZK protocols by distributing the task among a cluster of machines. However, this requires modifying the ZKP protocols to be amenable to distributed computation and manually partitioning the computation into smaller chunks to be proven in parallel. These manual processes may introduce errors and lead to suboptimal solutions, especially for statements of real-world complexity.

Accordingly, there is a need in the art for articles and methods that improve on existing articles and methods for partitioning, parallelizing, and solving ZKPs. The present invention addresses this need.

### SUMMARY OF THE INVENTION

In one aspect, a method of parallelizing zero-knowledge (ZK) protocols includes providing a ZK framework; calculating local and communication costs for each program instruction of a ZK statement; automatically partitioning the ZK statement according to the calculation; and distributing the partitioned ZK statement to a corresponding number of computing cores for parallel proving or verification. In some embodiments, the distributed ZR statement includes randomized verification.

In some embodiments, the calculating includes determining sums of the maximum per-machine cost and cumulative communication costs. In some embodiments, the partitioning of the ZK statement includes chunking the ZK statement to provide a lowest or substantially lowest sum of the maximum per-machine cost and cumulative communication costs based upon the calculation.

In some embodiments, the partitioning of the ZK statement is arbitrary. In some embodiments, the ZK framework permits proving multiple statements of a single witness while ensuring consistency. In some embodiments, the framework is configured to execute a commit-and-prove paradigm. In some embodiments, the method further includes a prover committing private inputs; and constructing a proof establishing some public relationship among the committed values; wherein the public relationship among the committed values is established without revealing the committed values to a verifier. In some embodiments, the method further includes establishing multiple statements on the private inputs.

In some embodiments, the partitioning comprises forming at least two substatements. In some embodiments, the method further includes preconputing the input/output of each substatement. In some embodiments, precomputing comprises forming an extended witness, the extended witness resolving data dependency.

In some embodiments, the partitioning includes shallow simulation and deep simulation. In some embodiments, the shallow simulation includes the automatic partitioning of the ZK statement; and selecting of variables as witnesses for each substatement. In some embodiments, the shallow simulation includes computing the costs of each instruction in the ZK statement using live variable analysis; and modeling the computed costs as a directed acyclic graph for partitioning. In some embodiments, the partitioning includes pseudo-Boolean optimization (PBO) or integer linear programming (ILP). In some embodiments, the deep simulation includes computing extended witness values using a prover's private inputs; and computing public variable values. In some embodiments, the computing of the extended witness values and public variable values includes propagating input-dependent values through the ZK statement.

In some embodiments, the framework includes annotation tools configured to identify knowledge levels. In some embodiments, the knowledge levels include private input-independent values known at compile time, private input-dependent values that are known at distribution time, and variables that are only known at runtime. In some embodiments, the private input-independent values and the private input-dependent values are allowed to flow into the variables that are only known at runtime, but the variables that are only known at runtime are not allowed to flow into the private input-independent values and the private input-dependent values. In some embodiments, the partitioning step includes treating the variables that are only known at runtime as a single contiguous block to estimate worth-case cost and enforce sequential ordering.

Also provided is an apparatus for parallelizing zero-knowledge (ZK) protocols, the apparatus including a processor; a memory unit; and a communication interface; wherein the processor is connected to the memory unit and the communication interface; and wherein the processor and memory are configured to implement the method of any of the embodiments disclosed herein.

Also provided herein is an apparatus for proving zero-knowledge (ZK) protocols, the apparatus including at least two processors; a memory unit; and a communication interface, wherein the processors are connected to the memory unit and the communication interface; and wherein a ZK statement parallelized according to the method of any of the embodiments disclosed herein is distributed among the at least two processors.

Further provided herein is a non-transitory computer readable storage medium storing computer-executable instructions for performing the method of any of the embodiments disclosed herein.

### BRIEF DESCRIPTION OF THE DRAWINGS

FIG. 1 shows an image illustrating an example of an Ou implementation of Freivalds' algorithm for randomized verification of 100×100 matrix multiplication.

FIG. 2 shows a schematic illustrating the DZKP framework, beginning with an Ou program and ending in binaries for an implementation of a ZKP protocol. Square blocks with light text identify the compiler components: the operations (blue) and their underlying methods (green). Dark text indicates a program or protocol: the Ou program (purple semi-rounded rectangle), compiled substatement binaries (gold rounded rectangles), and the ZKP protocol itself (light blue diamond). Corresponding knowledge levels are displayed as well.

FIG. 3 shows a schematic illustrating a security lattice.

FIG. 4 shows an image illustrating the syntax of the Ou language compiling a reconciliation step into the binaries themselves, which requires no additional expertise on behalf of the verifier.

FIG. 5 shows an image illustrating typing rules.

FIG. 6 shows an image illustrating shallow semantics.

FIG. 7 shows a schematic illustrating shallow semantics refinement.

FIG. 8 shows a schematic illustrating deep semantics refinement.

FIG. 9 shows a schematic illustrating execution in a chunk.

FIGS. 10A-10B show the effective ratio for the distribution scheme found by DZKP for the gradient descent (GD) programs with (A) different numbers of iterations and (B) various numbers of machines (K). With the increase in K, the effective ratio will reach the limit. A small-size program with a large x will make the effective ratio of the distribution scheme much smaller than k.

FIGS. 11A-B show graphs illustrating that the effective ratio for the distribution scheme found by DZKP for the MT programs is close to (A) the numbers of machines (k) with (B) different numbers of input blocks and k.

FIG. 12 shows graphs illustrating that compiling takes significantly greater time for GD programs when the function update_all( ) is not annotated with the atomic keyword. On the other hand, atomic annotation rules out some feasible solutions, making the distribution scheme slightly suboptimal.

FIG. 13 shows graphs illustrating that adding annotation improves both the effectiveness of both compilation and the effective ratio of the MT program for 32-block input.

FIG. 14 shows an image illustrating a merkle tree (MT) example.

FIG. 15 shows an image illustrating MT after shallow simulation.

FIG. 16 shows a schematic illustrating a MIT dependency graph.

FIG. 17 shows an image illustrating MT generated programs.

FIG. 18 shows an image illustrating dynamtic semantics.

FIG. 19 shows schematics illustrating conversion of symbolic values and expressions.

FIG. 20 shows graphs illustrating the effect of adding atomic annotations to the MT program for 16-block inputs.

FIG. 21 shows graphs illustrating the effect of adding atomic annotations to the MT program for 64-block inputs.

FIG. 22 shows graphs illustrating the effect of adding atomic annotations to the MT program for 8-block inputs.

FIGS. 23A-D show program structures of GD and MT under different conditions. (A) Program structure of gradient descent ((GD)) with update all(annotated with atomic keyword. (B) Program structure of GD without update_all( ) being atomic. (C) Program structure of merkle tree (MT) with sha256_node(annotated with atomic keyword. (D) Program structure of MT without sha256 node( ) being atomic.

### DETAILED DESCRIPTION OF THE INVENTION

### Definitions

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20% or ±10%, more preferably ±5%, even more preferably ±1%, and still more preferably ±0.1% from the specified value, as such variations are appropriate to perform the disclosed methods.

Ranges: throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### DETAILED DESCRIPTION

Provided herein are methods of parallelizing zero-knowledge (ZK) protocols. In some embodiments, the method includes providing a ZK framework, calculating local and communication costs for each program instruction of a ZK statement, automatically partitioning the ZK statement according to the calculation, and distributing the partitioned ZK statement to a corresponding number of computing cores for parallel proving or verification.

In some embodiments, the programming framework permits programmers to focus on writing ZK applications without worrying about the complexities of distributed computation. Additionally or alternatively, in some embodiments, the ZK framework includes a programming language with annotations that make it easy for developers, even those without extensive cryptography knowledge, to write ZK applications using advanced protocols. Suitable programming languages include, but are not limited to, C-like programming languages. In some embodiments, the framework includes annotations for identifying the public or private nature of information and/or the knowledge level of the information. For example, in one embodiment, the knowledge levels include private input-independent values known at compile time (K₀), private input-dependent values that are known at distribution time (K₁), variables that are only known at runtime (K₂), and/or any other suitable knowledge level for variables/values of the ZK statement. Accordingly, in some embodiments, the method includes specifying non-interference along two dimensions, such as, but not limited to, the public or private nature of the information and the knowledge level of the information.

In some embodiments, the framework includes a compiler and a static analysis pipeline. In some embodiments, the framework focuses on a commit-and-prove paradigm, where the prover first commits to their private inputs, and then constructs a proof establishing some (public) relationship among the committed values without revealing them to the verifier. The framework calculates the local and communication costs of each program instruction, then automatically chunks, or partitions, the corresponding ZK statement according to the calculations. In some embodiments, the framework performs the calculating and partitioning steps using two compilation phases—shallow simulation and deep simulation, in such embodiments, for example, the shallow simulation automatically partitions the ZK statement and then selects variables as witnesses for each of k substatements. In some embodiments, the parameter k is user-chosen, and equals the number of available compute cores in the cluster. Following shallow simulation, the deep simulation then uses a prover's private inputs to concretely compute the values of extended witnesses, as well as of any public variables. In some embodiments, prior to the shallow simulation, the method includes parsing and/or typechecking the program.

The shallow simulation proceeds by using live variable analysis to compute the costs of each instruction in the ZK statement, and then models them as a directed acyclic graph for partitioning. A non-limiting example of live variable analysis is discussed in Section 5.1 of Example 1 herein. The live variable analysis tracks dependencies among independent blocks formed from the instructions, and the results of the live variable analysis are used to decorate the graph with both edge and node labels. Each edge and node label indicates a form of cost to the partition. For example, in some embodiments, the nodes are labeled with their computation cost while edges are labeled with the cutting cost. The computation cost models the time required by the prover and verifier to execute the block's proving or verification operations in the chosen ZKP protocol backend. The cutting cost models the communication cost required to reconcile the state of the blocks across compute nodes in the cluster.

After labeling the edges and nodes, the ZK statement is partitioned by any suitable method, such as, but not limited to, pseudo-Boolean optimization (PBO) or integer linear programming (ILP). The partitioning cuts, or chunks, the ZK statement to provide the lowest or substantially lowest sum of the maximum per-machine cost and cumulative communication costs, as calculated from the costs associated with the labels. A non-limiting example of the cutting is discussed in Section 5.2 of Example 1 herein.

Following partitioning, the partitioned program is compiled into binaries for any suitable chosen ZKP protocol backend. Suitable backends include, but are not limited to, public-coin zero-knowledge proofs, private-coin zero-knowledge proofs, NIZK protocols obtained via the Fiat-Shamir (FS) transformation, NIZK protocols obtained without FS transformation, and/or any other suitable backend. In some embodiments, all computation through shallow simulation is based only on public information. Accordingly, in such embodiments, the binaries may be freely distributed and reused without divulging private information. In some embodiments, the shallow simulation produces a sequential program including a flattened sequence of operations through loop unrolling and function inlining. In some embodiments, every instruction in the original program, with the exception of constituent instructions of functions decorated by the atomic keyword and all K₂-annotated variables, forms its own independent block in the sequential program.

The deep simulation then computes dependent values between partitions to facilitate running of the programs in parallel. In some embodiments, deep simulation includes a prover simulating execution of each substatement program using their private information, then saving the output values of each one that then becomes the input to others. These output values are referred to herein as the extended witnesses. After all the chunks have been checked in parallel, their inputs and outputs are reconciled to check consistency of variables passed across the cuts. In some embodiments, a proof with different inputs may include recomputing only the deep simulation, and not the shallow simulation or partitioning (which is likely to be the most computationally intensive compilation task).

In some embodiments, the methods disclosed include randomized verification, which in turn supports general-purpose ZK. In some embodiments, the methods disclosed herein provide arbitrary partitioning of the ZK statement. Additionally or alternatively, in some embodiments, the method permits proving multiple statements of a single witness while ensuring consistency. In some embodiments, the method includes allowing the private input-independent values and the private input-dependent values to flow into the variables that are only known at runtime, but not allowing the variables that are only known at runtime to flow into the private input-independent values and the private input-dependent values. This flow of values enforces non-interference with respect to a security lattice, ensuring the security and correctness of resulting ZK programs when randomized verification are introduced. In some embodiments, the security lattice specifies non-interference along two dimensions: (1) the public or private nature of the information, and (2) the knowledge level of the information (e.g., if the information is available at compile time, distribution time, or run time). In such embodiments, the lattice defines seven security domains, as discussed in detail in the Examples section below.

In some embodiments, the method includes sublinear representation through a user-provided annotation to indicate that a function should be condensed, rather than flattened, during the shallow simulation. The user-provided annotation is also referred to herein as atomic. By condensing, rather than flattening, during the shallow simulation, the component of the cost graph corresponding to the function is contracted into a single node of cost cumulative of its constituent instructions. This reduces the size of the graph and facilitates optimization of large statements. In some embodiments, even if the atomic function is called multiple times, only one copy of the declaration exists. This enables the partitioning of large ZK statements for both PBO and ILP solving, despite its inherent hardness. Accordingly, in some embodiments, the method may be scaled to large ZK statements.

Also provided herein, in some embodiments, is an apparatus for parallelizing zero-knowledge (ZK) protocols, the apparatus including a processor, a memory unit, and a communication interface. The processor is connected to the memory unit and the communication interface, and the processor and memory are configured to implement the method according to any of the embodiments disclosed herein. Additionally or alternatively, in some embodiments, the apparatus includes an apparatus for proving zero-knowledge (ZK) protocols. In such embodiments, the apparatus includes at least two processors, a memory unit, and a communication interface. The processors are connected to the memory unit and the communication interface, and a ZK statement parallelized according to any of the methods disclosed herein is distributed among the at least two processors.

Further provided herein, in some embodiments, is a computer readable storage medium storing computer-executable instructions for performing the method according to any of the embodiments disclosed herein.

Without wishing to be bound by theory, it is believed that the articles and methods disclosed herein facilitate the practical implementation of Zero-Knowledge Proofs (ZKP) in real-world software, overcoming the limitations of existing ZKP implementations. Additionally, the framework disclosed herein permits non-expert programmers to effortlessly write efficient and intuitive ZKP programs. Furthermore, the articles and methods disclosed herein facilitate the scalability and cost savings offered by distributed computing, which is especially advantageous for computationally intensive ZKP programs or those involving large amounts of data. By distributing the workload across multiple machines, computations can be completed faster, and the burden on programmers is reduced through automatic parallelization. This simplifies the creation of complex ZKP applications that leverage distributed computing, without requiring specialized knowledge of distributed systems or parallel programming. Accordingly, the articles and methods disclosed herein may be applied to various applications such as, but not limited to, blockchain privacy and scalability, legal systems, and anonymnous networks.

Those skilled in the art will recognize, or be able to ascertain using no more than routine experimentation, numerous equivalents to the specific procedures, embodiments, claims, and examples described herein. Such equivalents are considered to be within the scope of this invention and covered by the claims appended hereto.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

The following examples further illustrate aspects of the present invention. However, they are in no way a limitation of the teachings or disclosure of the present invention as set forth herein.

### EXAMPLES

### Example 1

### Abstract

A zero-knowledge proof(ZKP) is a powerful cryptographic primitive used in many decentralized or privacy-focused applications. However, the high overhead of ZKPs can restrict their practical applicability. This Example describes the design of a programming language, Ou, aimed at easing the programmer's burden when writing efficient ZKPs, and a compiler framework, DZKP, that automates the analysis and distribution of statements to a computing cluster DZKP uses programming language semantics, formal methods, and combinatorial optimization to automatically partition an Ou program into optimally sized chunks for parallel ZK-proving and/or verification. Discussed herein are:
(1) A front-end language where users can write proof statements as imperative programs in a familiar syntax;
(2) A compiler architecture and implementation that automatically analyzes the program and compiles it into an optimized IR that can be lifted to a variety of ZKP constructions; and
(3) A cutting algorithm, based on Pseudo-Boolean optimization and Integer Linear Programming, that reorders instructions and then partitions the program into optimally sized chunks for parallel evaluation and efficient state reconciliation.

### 1. Introduction

Zero-knowledge proofs (ZKPs) (Oded Goldreich, Silvio Micali, and Avi Wigderson. 1986. Proofs that Yield Nothing But their Validity and a Methodology of Cryptographic Protocol Design (Extended Abstract). In 27th FOCS. IEEE Computer Society Press.) enable a prover to convince a verifier about the truth of some statement without revealing why. Recent advances by the cryptographic research community have brought a tremendous improvement in the efficiency of general-purpose zero-knowledge (ZK) proving, as well as numerous creative applications of ZKPs (e.g., reputation systems of anonymous networks, decentralized cryptocurrency, decentralized private computation) However, various practical challenges make the adoption of ZK unfeasible for tasks of realistic sizes. A particular problem is the lack of a comprehensive toolkit of programming languages and compilers providing a full suite of effective, intuitive, parallel-aware, and general methods for writing complex statements intended for efficient ZKPs.

Challenge 1: Simple and scalable development. One significant challenge for applying ZKPs to new problems is describing the statement to be proven in a way that is at the same time natural to the programmer and conducive to compilation.

Most existing languages and compilers for ZK (and for the closely related problem of secure multiparty computation, or MPC) support only the ‘circuit model’ based on data-oblivious computation, where control flow must be independent of all private variables. They encode the statement as a monolithic program and emit an appropriate circuit representation for their target protocol. Although this model is theoretically complete, it does not capture the full flexibility and power of modern ZKP constructions. For example, many statements can be accelerated by non-determinism, where the prover provides extra hints to the computation. Other statements (e.g., 3-coloring and Hamiltonian cycles in graphs) can be verified with high concrete efficiency under a probabilistic guarantee: the verifier provides extra random challenges, to which the prover replies with challenge-dependent hints.

Provided in this Example is a more general-purpose ZK programming framework able to support proofs over multiple computational models. The aim is to ease development for new domains—especially so for ZK statements that are more naturally expressed in those alternative models, or for which those models provide superior performance.

Challenge 2: Scalability in hardware resources. All sufficiently advanced technology may be indistinguishable from magic, but the ‘magic’ of ZK often depends as much in practice on massive hardware resources as on mathematical ingenuity. These demands lead to practical bottlenecks in computation and/or communication resources when scaling ZKPs to large statements. For example, most zkSNARK protocols require temporary storage linear in the running time of the computation being proved. Although VOLE-based ZKPs use less memory, they only do so at the expense of a significant increase in required bandwidth. To aid practicality, a line of recent work has started to “scale out” ZK protocols: instead of assuming the prover and/or verifier have access to one giant machine, they assume access to a cluster of machines and the capability to distribute the task amongst these resources. For example DIZK distributes the prover computation of Groth's ZK protocol by manually partitioning the RICS constraints into equal-sized chunks. zkBridge can distribute the prover computation of Virgo efficiently to multiple servers when the statement already has a high degree of parallelism. Meanwhile, EZEE distributes among multiple machines the prover-verifier computation and communication of an interactive, garbled-circuit-based zero-knowledge proof protocol. Giraffe addresses the challenge of automatically distributing computations in the verifiable outsourcing context by breaking down overly large computations that cannot be outsourced as a whole.

Though efficient in deployment, in order to distribute their chosen ZK protocol over a cluster of servers each of these works require the developer to first both i) modify the ZKP protocols to be amenable to distributed computation; and ii) to manually partition the computation into smaller chunks to be proven in parallel. Such manual processes may be error-prone and lead to suboptimal solutions, especially for statements of real-world complexity.

### 1.1 Summary of Example

This Example describes the design of a programming framework—a language Ou and a supporting compiler architecture DZKP—enabling programmers to write zero-knowledge statements without thinking about distributed computation. The compiler automatically and optimally chunks this program for efficient parallel proving or verification.
(1) The framework provides a C-like programming language with annotations so that developers, including those without deep knowledge of cryptography, can easily write ZK applications even when using protocols with advanced features.
(2) Developed herein is a compiler and static analysis pipeline, written in OCaml, that calculates the local and communication costs of each program instruction, then automatically finds an efficient way to chunk the corresponding ZK statement. The optimality measure minimizes the sum of the maximum per-machine cost and cumulative communication costs. This analysis can distribute ZK statements incorporating randomized verification.
(3) The system is proved sound, i.e., it is shown that the semantics of the distributed verification of substatements is equivalent to verifying the whole statement centrally.
(4) Empirically it is shown that for many statements, including gradient descent and Merkle Tree, the framework described herein can automatically find almost optimal partitioning of the statements, thus achieving speedup proportional to the number of machines available.

It is assumed that a program written in the language described herein is sound and secure for its intended ZK application, and is suitably constructed for the target protocol: e.g., it is assumed that the program is data-oblivious if the target is circuit-based,

### 1.2 Technical Challenges and Solutions

Ou and DZKP address a series of challenges arising from each of language design, cryptography, and combinatorial optimization.

Cryptographic insight. To enable arbitrary partitioning of a statement, the underlying ZK protocol needs to be ‘flexible’: it must allow proving multiple statements of the same witness while ensuring consistency. To this end, the present framework focuses on the commit-and-prove paradigm. The prover first commits to their private inputs, and then constructs a proof establishing some (public) relationship among the committed values without revealing them to the verifier. Because the inputs are committed the prover can establish multiple statements on them, all while the verifier is certain their values remain consistent. Any ZKP system can support this capability by proving the consistency of commitments in ZK, but certain protocols have direct support which incurs less cost. Given such a ZK backend secure under parallel composition, regardless of its internals, e.g., the use of Fiat-Shamir or random oracle, the proof of any ZK statement can then be distributed in parallel.

During compilation, the statement is first partitioned into multiple substatements, before the prover precomputes the input/output of each substatement locally. The prover can then in parallel prove to the verifier the correctness of each substatement and then establish the consistency of the input/output between substatements. Although this works in principle, designing a scalable system that automatically distributes the computation with minimum runtime- and developer-overhead is still challenging. For example, in ZK data dependency rarely constrains statement partitioning, unlike in normal computation or NPC where it does so always. So in ZK even inherently sequential statements can often be parallelized.

Automatic statement partitioning. In ZK the prover knows both the public and private inputs, and can thus ‘predict’ all intermediate values. As a result, data dependencies can be resolved before proving: computation of y=ƒ(g(x₁), x₂) can be partitioned into two parallel verification tasks, t=g(x₁) and y=ƒ(t, x₂). The prover, with inputs x₁ and x₂, just appends t to form an extended witness. For ordinary computation this parallelization would be infeasible, because ƒ depends on g. The prover's ability to ‘locally precompute’ creates new opportunities to maximize parallelism.

To partition effectively, after parsing and typechecking the present architecture undertakes two distinct special compilation phases: shallow simulation and deep simulation. The first automatically partitions the ZK statement and then selects variables as witnesses (the appendices to the input, like t) for each of the K substatements. The parameter K is user-chosen, and will equal the number of available compute cores in the cluster. Deep simulation then uses the prover's private inputs to concretely compute the values of those extended witnesses, as well as of any public variables.

Shallow simulation proceeds by using live variable analysis to compute the costs of each instruction in the statement, and then models them as a directed acyclic graph for partitioning by either pseudo-Boolean optimization (PBO) or integer linear programming (ILP). This requires loop unrolling and function inlining as flattening techniques. The resultant ZK substatements are then compiled to the chosen backend protocol implementation for distribution as programs to the participating servers: the evaluation herein uses the VOLE-based EMP-toolkit (Xiao Wang, Alex J. Malozemoff, and Jonathan Katz. 2016. EIP-toolkit: Efficient MultiParty Computation Toolkit.). DZKP's deep simulation then propagates input-dependent values through the statement to concretely compute both public values and the prover's witnesses for each substatement. To distinguish which values are available during different simulation phases, know/edge levels: K₀ for (private input-independent) values that are known at compile time, and K₁ for (private input-dependent) values that are known at distribution time are used. This way, reusing a proof with different inputs only requires recomputing the deep simulation, and not the shallow simulation or partitioning, where the latter is likely to be the most computationally intensive compilation task.

Supporting randomized verification. As noted, randomized verification can be much more efficient than deterministic verification. However, supporting it during shallow simulation in particular is a challenge. With deterministic verification an oblivious program trace is known at compile time, which allows DZKP to analyze the cost of each substatement easily. With randomized verification the program might branch on the at-the-time unknown randomness, preventing the cost from being calculated precisely as whether an expensive statement is entered may depend on a coin flip. Also, privacy imparts an ordering requirement on randomized verification: the verifier's randomness used in checking a ZK statement can only be revealed after the prover commits to its inputs. This means that the partitioning needs to obey sequential ordering for values that are dependent on dynamic choices of the verifier.

Ou uses a third knowledge level, K₂, to indicate that the value of a variable can only be known at runtime. The type system enforces non-interference with respect to a security lattice, allowing K₀- and K₁-leveled variables to flow into K₂-leveled variables, but not the other way around. The partitioning then treats the K₂-leveled variables as one contiguous block in order to estimate worst-case cost and enforce sequential ordering.

Handling large statements. Naively implementing the aforementioned techniques does not scale to large ZK statements. If the cost graph contains too many nodes then finding optimal or close-to- optimal chunks will be computationally infeasible. Classical graph partitioning and many related variants are NP-hard with efficient (approximate) optimization algorithms known only in certain special cases, and even then often only theoretically. More subtly, a naive representation of each substatement, e.g, as a circuit or RICS, is necessarily linear in its running time. For large statements, especially those containing unrolled loops or inlined function calls, it is therefore crucial to work with ‘compact representations’ of substatements which are sublinear in the running time.

Ou and DZKP support sublinear representations through atomic, a user-provided annotation to indicate that a function should be condensed, rather than flattened, during shallow simulation. By doing so, we contract the component of the cost graph corresponding to the function into a single node of cost cumulative of its constituent instructions. This reduces the size of the graph and makes optimization more practical. Even if the atomic function is called multiple times, only one copy of the declaration exists. This brings the partitioning problem into the realm of practicality for both PBO and IP solving, despite its inherent hardness.

### 1.3 Roadmap

Sec. 2 is an overview of the DZKP framework's workflow. Sec. 3 presents the language's syntax, typing rules, and dynamic semantics. Sec. 4 shows how the shallow simulation unfolds the program into a sequential program, and formally proves the two programs have the same behavior. Sec. 5 then describes how the compiler partitions the sequential program into multiple chunks and generates a distributed program. Sec. 6 shows how the deep simulation evaluates all dependent data between chunks. It also proves that with these data, the distributed program has the same behavior as if it was run without distribution. Finally, Sec. 7 studies the effectiveness of the framework for distributing the computations of various benchmarks.

### 2. DZKP Design Overview

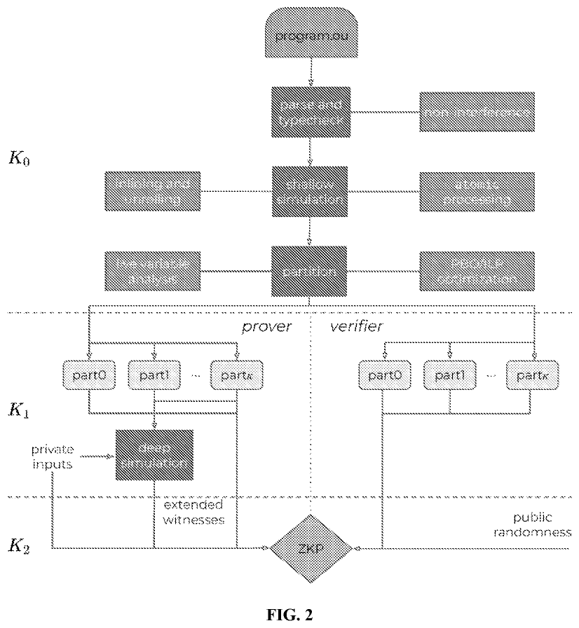

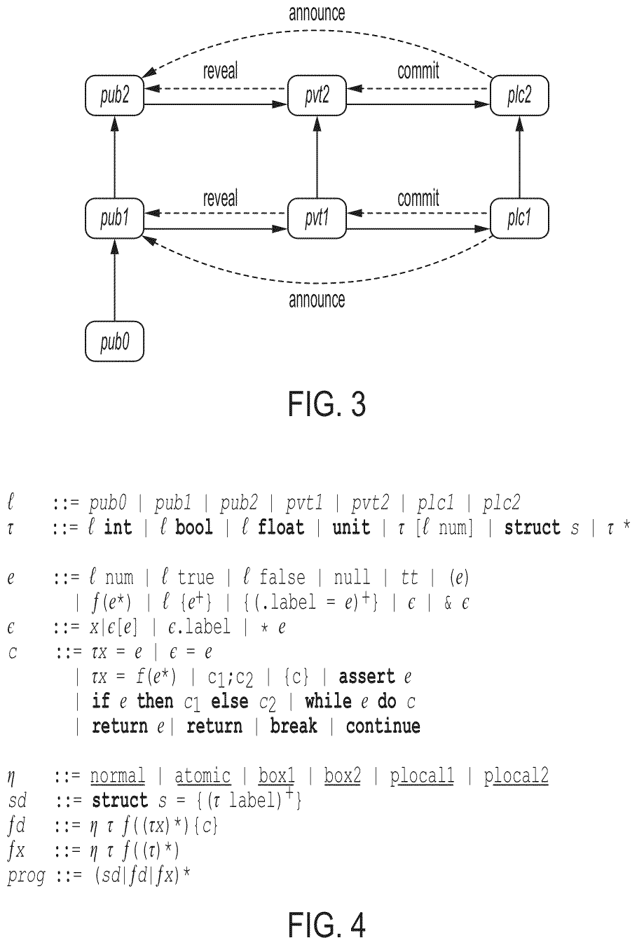

FIG. 2 shows the architecture and workflow of the DZKP framework. The user first writes a program in Ou. Upon invocation, the compiler parses and typechecks the program. The Ou type system enforces non-interference over the security lattice given in FIG. 3. This lattice specifies non-interference along two dimensions:
i the public or private nature of the information; and
ii the knowledge level of the information (i.e., if the information is available at compile time, distribution time or run time)
   Accordingly, the lattice defines seven security domains: public pub x {K₀, K₁, K₂}, committed and authenticated pvt×{K₁, K₂}, and prover-local plc x {K₁, K₂}. As syntactic sugar, we write pub0 for (pub, K₀) and similarly for the rest of the lattice. The variables in the public domain are known by both the prover and the verifier, the variables in the prover-local domain are only known by the prover, and the variables in the authenticated domain are only known by the prover but the verifier holds a commitment to them. Since values known at compile time can only be public, (pvt, K₀) and (plc, K₀) do not exist.

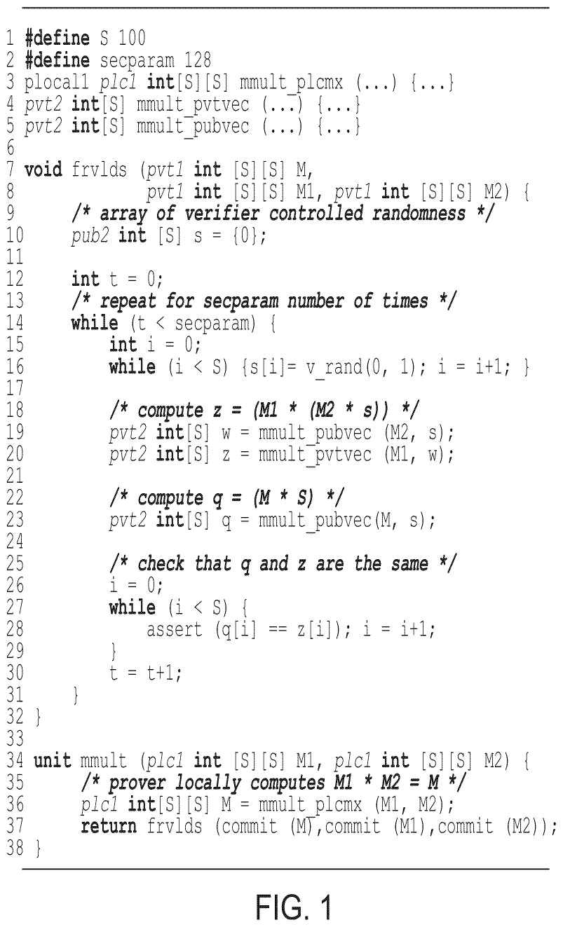

The authenticated and prover-local variables contain information computed from the prover's secret inputs. Public variables are usually used to guide the program's execution, either deterministically as iterators or fixed constants, or as verifier-provided randomness. In a valid OU program every variable is annotated by the security label of a position in the lattice. ¹For example, in FIG. 1 pub0 annotates the public matrix size constant S that is known at compile time. In comparison, further up the lattice pvt2=: (pvt, K₂) annotates w, which depends on both the prover's committed private values (M2, necessitating pvt) and on the verifier's public randomness (s, necessitating K₂).

The security lattice enforces that the private and prover-local domains' information never flow into the public domain except by explicit lowering through a reveal operation. This non-interference property (Joseph A. Goguen and Jose Meseguer. 1982. Security Policies and Security Models. In 1982 IEEE Symposium on Security an Privacy. Oakland, CA, USA, Apr. 26-28, 1982. IEEE Computer Society, 11-20; Andrei Sabelfeld and Andrew C. Myers. 2003. Language-Based Information-Flow Security. IEEE Journal on Selected Areas in Communications 21, 1 (2003), 5-19.) allows the safe partial execution of the program during compile time (the shallow simulation), as the control flow can be pre-determined. The inclusion of the knowledge levels in the security lattice is essential to guaranteeing that reveal operations and public verifier-randomness are safely handled under the non-interference guarantee.

Once typechecking completes shallow simulation commences. Shallow simulation yields ¹The parser accepts unannotated declarations, which are interpreted as pub0 a sequential program consisting of a flattened sequence of operations through loop unrolling and function inlining. With two exceptions, every instruction in the original Ou program forms its own independent block in this sequential program: the constituent instructions of functions decorated by the atomic keyword are combined into a single block, as are all K₂-annotated variables. In both cases, this mapping enforces they be treated as one cumulative ‘instruction’ for the purposes of partitioning. In FIG. 1 for example, the suffix of the program beginning with the first mmult_pubvec call on L19 will be condensed, thereby guaranteeing the security of the parallel composition in the presence of public randomness.

If the user sets k=1, so that only a single partition is desired, then this sequential program will be directly compiled into the ZK statement as specified by the backend. However, usually k>1 as the developer desires parallelization, and this is generally assumed to hold through the remainder of this discussion. The DZKP compiler next conducts live variable analysis to track dependencies among the blocks and builds a corresponding directed acyclic graph G=(V,E). An edge (i, j)∈E captures that j-th instruction block depends on some information computed in the i-th instruction block. For example, in FIG. 1 the commit(M) on L37 depends on the mmult_plcmx block on L36.

In order to partition optimally, the results of the live variable analysis are used to decorate G with both edge and node labels, each indicating a form of cost to the optimality of any partition. Nodes in G are labeled with their computation cost, which models the time required by the prover and verifier to execute the block's proving or verification operations in the chosen ZKP protocol backend. Edges are labeled with the cutting cost, which models the communication cost required to reconcile the state of the blocks across compute nodes in the cluster. The latter is linear to the operation's inbound dependent data. It is assumed that cutting and computation costs are directly comparable through some scaling factor (cr), but that detail is otherwise omitted as it is irrelevant to the function of the compiler.

DZKP next uses combinatorial optimization to find the optimal cuts to partition G. This optimization problem is most easily understood as an ILP, though as the constituent variables are all Booleans it is amenable to representation as a PBO problem as well.

The opt(·) function is formally given for this problem, as well as all of its constraints, in Sec. 5.2. Informally, the objective can be understood as the maximum of the cumulative computation costs of each partition, plus the sum of all cutting costs on edges bisected by the k−1 cuts (needed to create the user-specified K chunks). Users can adjust the parameters of the ILP/PBO instances or objective functions to align with different ZK backends and relevant metrics.

The partitioned program is compiled into binaries for the chosen ZKP protocol backend. As DZKP is designed to use commit-and-prove ZK protocols as a black box without any intern changes of them, our highly adaptable framework can support a wide range of backends, including the NJZK protocols obtained via the Fiat-Shamir transform (Mihir Bellare and Phillip Rogaway, 1993. Random Oracles are Practical: A Paradigm for Designing Efficient Protocols. In ACC CCS 93, Dorothy E. Denning, Raymond Pyle, Ravi Ganesan, Ravi S. Sandhu, and Victoria Ashby (Eds.). ACM Press.). These binaries are then sent to any and all individual provers and verifiers. All computation up to this point is based only on public K₀ information, and so the binaries may be freely distributed and reused. However, for the programs to run in parallel, the dependent values between partitions must be computed ahead of time. This is the deep simulation. The prover uses their private information to simulate execution of each substatement program, and saves the output values of each one that then become the inputs to others. These output values are the ‘extended witnesses’ of FIG. 2, For example, in FIG. 1 a cut at L12 would make each entry in M an extended witness. After deep simulation completes, the prover can, with any verifier, execute the ZKP protocol by running their binaries in parallel and connecting each binary to the other party's running copy over the network (i.e., part0 to part0, part1 to part1, and so on up to partk).

Finally, after all the chunks have been checked in parallel, their inputs and outputs must be reconciled to check consistency of variables passed across the cuts. This step prevents the prover from violating soundness by inconsistently computing their extended witnesses, so that, e.g., some variable t=0 in one partition but t=1 in another Therefore the runtime of the proving is not only a function of how large each of the partitioned substaternents are, but also of how much state must be communicated amongst the compute cores during this consistency checking step—justifying its inclusion in the optimization objective. DZKP automatically compiles this reconciliation step into the binaries themselves, so it requires no additional expertise on behalf of the verifier.

### 3. Ou Language

### 3.1 Language Syntax

FIG. 4 demonstrates Ou's syntax. Note that a⁺ is used as short-hand for one or more non-terminals separated by commas like a₁, . . . , aₙ, and a* is used to represent zero or more non-terminals likewise. A program consists of a collection of struct declaration (sd), function declaration (fd), and external function declaration (fx) statements. There must exist a main function acting as the entry point to the entire program. The syntax is very similar to many imperative languages, except for the addition of security levels [symbol] to label primitive types and annotations η to label certain functions.

Each atomic type τ is annotated with a security level [symbol] . Arrays have both a τ indicating their elements' type, as well as an ƒ indicating their access level. The access level can be viewed as the security level of indexes. A struct's type only mentions its name, and not its fields, so that we can support recursive struct definitions.

There are two different kinds of expressions: L-expressions (ϵ) and R-expressions (e) An L-expression refers to a memory location like a variable x, an array index ϵ[e], a struct field ϵ.l, or a dereferenced pointer *e. An R-expression represents a value like an integer, float, or Boolean constant; the calling of a builtin function, array constructor, or struct constructor; or the loading of an L-expression or a pointer to an L-expression. When constructing an array [symbol] {e₀, . . . , eₙ₋₁}, the user has to specify its access level. The user can also write normal binary and unary operators, including typecasting following the arrows in FIG. 3, and all typical arithmetic operations on integers, floats, and Booleans, but DZKP will automatically convert them into builtin function calls. For example, given a variable x of type pvt1 int and a variable y of type pub0 int, x+y will be automatically rewritten into the expression pvt1_int_add(x, pvt1_int_of_pub0(y)).

A command c can be a variable declaration, an assignment, the calling of a user-defined function, conditional branching, a while loop, a sequence of commands c₁; c₂, a block of commands, returning from a function, or breaking out of a loop.

Note the syntax treats builtin functions and user-defined functions differently. A builtin function ƒ can be called in expressions freely, while a user-defined function ƒ has to be received immediately by a variable. This distinction is needed because all builtin functions are pure while user-defined functions can have side-effects. As shallow simulation will reorder computations, having side-effects in expressions can alter behavior. Calling user-defined functions freely in any expression is still allowed, but just like in C the programmer cannot assume any execution order as DZKP will automatically rewrite the code to extract these calls.

Each function also has an annotation η which enforces restrictions on its body. Most common are normal functions (the parser interprets unannotated functions as normal) which only permit branching on pub0 Boolean expressions. An atomic function is similar, except that shallow simulation will not unfold its body. To branch on a pub1 value, the user must write the code inside a box1 finction, while box2 is similar except for additionally allowing branching on pub2 variables. Functions annotated by plocal1 or plocal2 are prover-local functions, which only manipulate plc1 or plc2 values respectively. Functions annotated by box or plocal are called sandboxedfunctions, as the type system enforces restrictions to isolate their effects. This is further elaborated in Sec. 3.2.

Before typechecking, DZKP first scans the program and collects some top-level definitions: Θ maps a struct name s to its definition {l₁: τ₁, l₂: τ₂, . . . } Λ^{u} maps a user-defined function name ƒ to its definition or declaration. When ƒ is defined, Λ^{u}(ƒ) is like internal (η, (τ₁x₁, . . . , τ₁xₙ)→τ, c) consisting of its annotation, parameter list, return type, and function body; When ƒ is external, Λ^{u}(ƒ) records only external (η,(τ₁, . . . , τ₁)→τ). Note the language does not support global variables, so the prover can only use external functions to communicate her secret with the program. In addition, the language has builtin functions' typing information Λ^{b}, which map a builtin function name ƒ to its signature (τ₁, . . . , τ₁)→τ. Builtins do not have an explicit function body c, but in Sec. 3.3 we will assign each a math interpretation (|ƒ|).

In order to ensure the security of ZKP programs, it is crucial for users to label witness variables as pvt accurately. Failing to do so can lead to information leakage. DZKP offers provably-sound typing rules that enable users to implement secure Ou programs. By implementing a type checker for these rules, DZKP can identify and report any errors resulting from incorrect usage of security levels or annotations that violate the typing rules.

### 3.2 Typing Rules

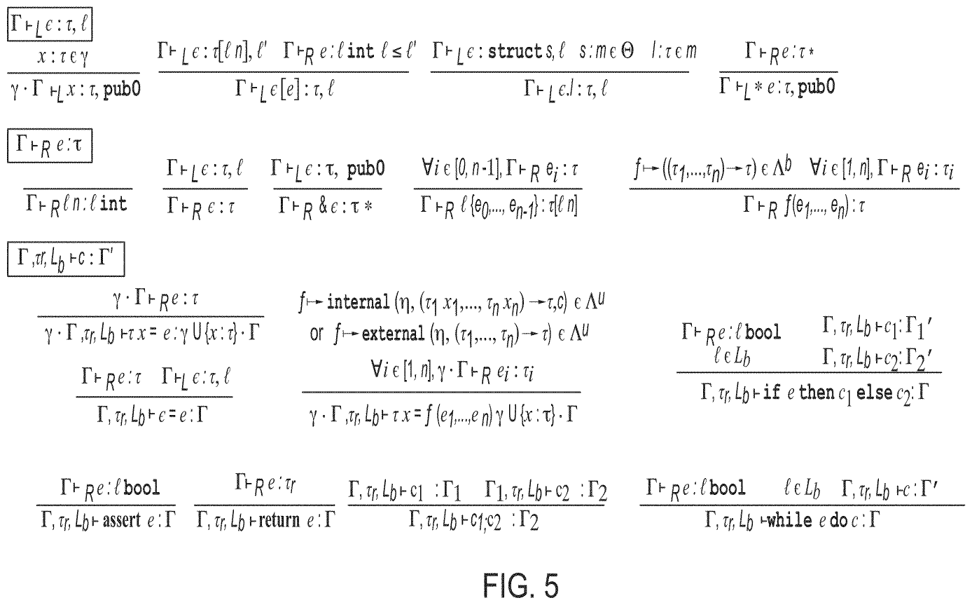

FIG. 5 demonstrates the language's typing rules. Each typing rule relies on the defined struct definitions Θ and function definitions Λ^{u} and Λ^{b}. As these are all fixed they are omitted from the written rules for concision. Also relied on is a typing environment F, which is a list of scopes γ₁ . . . γₙ. Each scope γᵢ maps variable names to their types. All newly defined variables reside in the first scope γ₁. Note that though the compiler allows the same name to be defined in different scopes, for clarity our discussion assumes that names never conflict.

Typing orders. We say [symbol] ≤ [symbol] if there's a path from [symbol] to [symbol] in FIG. 3. We say a type r is well formed if:
it is an atomic type like [symbol] int or [symbol] bool:
it is struct s such that's is defined in Θ and the types of all its fields are wellforned; or
it is an array of type τ[ [symbol] n] such that r is wellformed and C is no greater than any security level in τ.
   For the last condition the relevant security levels include those of the atomic type as well as the array's access levels. Wellformedness guarantees the values loaded from arrays are never less secure than the access needed to load them. This restriction is important for both shallow simulation and deep simulation as they need to fully evaluate all Ku expressions and K₁ expressions, respectively. For example, if a[e] loads a pub0 integer from array a with pvt1 access, then shallow simulation does not have enough knowledge to evaluate e, thus it cannot know which value is loaded. So although a[e]'s type is pub0, the shallow simulation cannot evaluate it. To make shallow and deep simulation behave as expected, it is assumed all types in this Example are wellformed.

Typing expressions. For L-expressions, Γ├_{L}ϵ: τ, [symbol] means in the typing environment F an L-expression E points to a value of type τ, and the L-expression itself has access level [symbol] . The access level can help determine whether an L-expression can be fully evaluated during shallow simulation (pub0) or deep simulation (pub1, pvt1 and plc1) or neither (pub2, pvt2 and plc2). Similarly, for R-expressions, Γ├_{R}e: τ means an R-expression e is of type τ in the typing environment F.

Note that in practice the DZKP compiler is more forgiving than the language's strict typing rules, as it performs implicit type conversion along the security lattice's arrows. For example, an expression e of type pub0 int can be used as a pvt1 int, and DZKP will automatically wrap it inside a casting function pvt1_int_of_pub0(e).

All pointers are also required to have pub0 access level. This restriction is important to the live variable analysis needed for partitioning. Suppose a pointer p were allowed to have a pvt1 access level: then shallow simulation could not evaluate the pointer itself in order to determine which location is mutated after running*p=e. This would mean all locations in the stack could potentially be the address. Similarly, loading a value from * p would mean any location could potentially be read. Therefore this restriction on pointer access levels is needed to make the live variable analysis yield meaningful results, rather than just concluding by labeling all variables as live.

Typing commands. When typechecking a command c which constitutes a function's body, its return type τᵣ is needed to guarantee that each return command in c yields a valid value. A set of branching security levels L_{b} are also needed to guard all branching expressions inside c. In normal and atomic functions, all branching expressions have to be pub0, but prover-local and boxed functions enforce fewer restrictions.

Typing a program. The type checker first checks all struct definitions, and makes sure there are no name collisions between struct names and field names, and then checks each function's body. For a function definition ητƒ(τ₁x₁, . . . , τₙxₙ){c}, the command's typing rule is applied on its body: Γ, τ, L_{b}├{c}Γ, where Γ={x₁:τ₁, . . . , xₙ:τₙ} and L_{b} is determined by η:

$${L}_{b} = \{ \begin{matrix}\{ pub 0 \} & if η is atomic or normal \\ \{ pub 0 , pub 1 \} & if η is box 1 \\ \{ pub 0 , pub 1 , pub 2 \} & if η is box 2 \\ \{ plc 1 \} & if η is plocal 1 \\ \{ plc 1 , plc 2 \} & if η is plocal 2\end{matrix}$$

There are additional restrictions placed on sandboxed functions. It is required that plocal1 and box1 functions only modify external data that is K₁ or K₂, and only return K₁ or K₂ results. Similarly plocal2 and box2 functions can only modify external data that is K, and only produce K₂ results. The reason is similar to the restrictions on arrays' access levels: shallow simulation cannot execute plocal1 or box1 functions, so it is infeasible to allow then to modify or return any K₀ data. If they could, simulation of any other computations that rely on such data could not proceed after the function call. It is also restricted that plocal functions can only manipulate plc data. Since all plocal functions only run on the prover's side they cannot include any pub or pvt values, as their use would require the verifier's participation.

To enforce the first restriction, only the function's signature needs to be examined: all pointers passed into plocal1 and box1 functions should only point to K₁ or K₂ data, while all pointers passed into plocal2 and box2 functions should only point to K₂ data. The return types have similar restrictions. Since the language does not support global variables, sandboxed functions can only update external data via the pointers in the arguments. To enforce the second restriction, the entire function body needs to be examined to make sure all expressions' types only have plc annotations, and the body only calls other plocal functions.

### 3.3 Dynamic Semantics

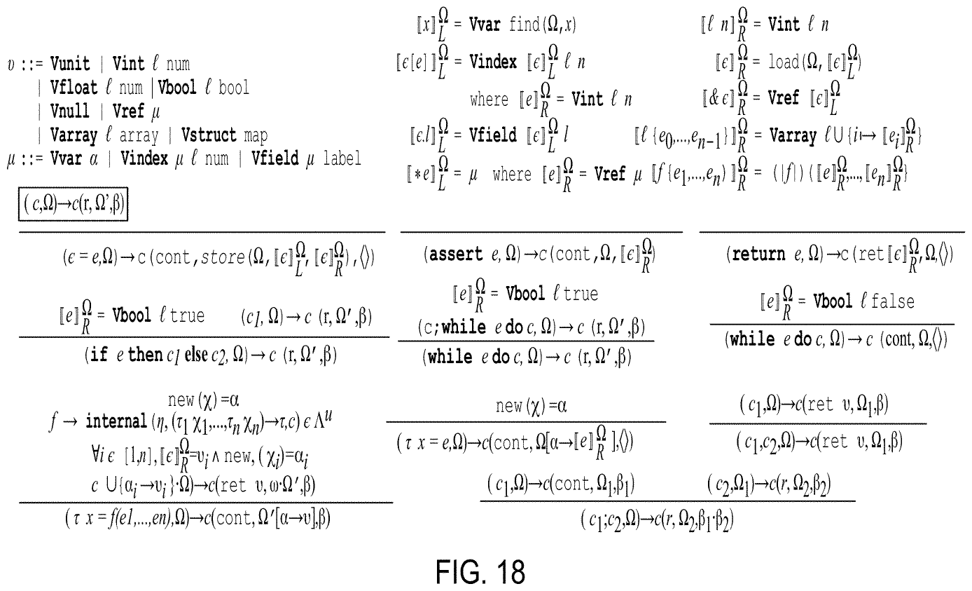

This section defines the dynamic semantics that apply if all secrets are known. The semantics correspond to the program's behavior in the ideal world where it has enough knowledge to fully evaluate all expressions into values and check if all assertions are satisfied. This semantics is used as a baseline to prove the simulation and distribution are correct. The semantics rules are not surprising. The detailed definitions are listed in Section 9 and shown in FIG. 18.

R-values and L-values. v is used to denote R-values (or “values” for short) and μ to denote L-values. R-values can be atomic values like Vunit and Vint [symbol] n, an empty pointer Vnull, a pointer Vref μ, an array Varray [symbol] a where [symbol] is the array's access level and a is a mapping from indexes to R-values like {0 [symbol] v₀, . . . , n [symbol] vₙ}, or a struct Vstruct m where n is a mapping from label to R-values like {l₀ [symbol] v₃, . . . , lₙ [symbol] vₙ}. An L-value is a reference to a memory location: it can be Vvar α that points to an alias, or Vindex μ [symbol] i that refers to an array μ's index i, or Vfield μ i that refers to a struct μ's field l. An alias is used by the stack to disambiguate during recursion, and can be viewed as a memory address.

$$v \text{::} = Vunit \vert Vnull \vert Vref μ$$

$$\vert Vint ℓ num \vert Vfloat ℓ num \vert Vbool ℓ bool$$

$$\vert Varray ℓ array \vert Vstruct map$$

$$μ \text{::} = Vvar α \vert Vindex μ ℓ num \vert Vfield μ label$$

The program runs on a stack Ω, i.e., a list of frames ω₁·ω₂ . . . ωₙ. The last frame ωₙ stores main's variables. The stack grows with nested function calls, and the top frame ω₁ stores the current function call's local variables. Each frame ω is a map from aliases to values. Ω[α [symbol] v] is used to denote adding a mapping α [symbol] v to the top frame. Whenever a new variable x is defined, DZKP allocates a unique alias new(x) for it. This is useful when recursion occurs, as the same variable x might have different instances in the stack, so their values cannot be bound to the same name x. A function find(Ω, x) is also used to find the latest alias allocated for x in the stack. Note that when x is defined for the first time, new(x) returns x directly instead of allocating a new alias for it.

Given a stack Ω, a function load(Ω, y) is used to load the value referred by μ in Ω, and a function store(Ω, μ, v) is used to compute the updated stack after replacing the value at μ with v. They both search the entire stack from top frame to bottom instead of working only with the top frame.

Semantics. The semantics look up the sets of user-defined functions Λ^{u} and builtin functions Λ^{b} to interpret function calls. As they are immutable, for concision they are omitted from the rules. Expressions:

$${〚 ϵ 〛}_{L}^{Ω}$$

computes L-expression ϵ in stack Ω and yields an L-value,

$${〚 ϵ 〛}_{R}^{Ω}$$

evaluates R-expression e and yields an R-value. Note DZKP assigns a mathematical interpretation (|ƒ|) for each builtin function ƒ which maps a tuple of R-values to an R-value. For example, (|pvt1_int_add|)(Vint pvt1 n, Vint pvt1 m)=Vint pvt1(n+m)

Commands: (c, Ω₁)→c(r,Ω₂, β) means that running a command c from a stack Ω₁ yields a sequence of assertion results β, a result r which is either cont or retᵥ, and a changed stack Ω₂. Since the command constitutes a function's body, retᵥ is used to mean the function returns with v and cont to mean it has not yet returned.

### 4. Shallow Simulation

Shallow simulation executes and unfolds the program with K₀ knowledge to obtain a simplified sequential program. DZKP will attempt as much simplification as possible, and output all unknown computations as a sequence of commands for later analysis and partitioning. All normal and atomic functions will be executed, but only the former's execution history will be output, while the latter will be output as indivisible calls. As sandboxed functions rely on K₁ or K₂ knowledge, they will not be executed in shallow simulation and will be kept in the generated sequential program.

### 4.1 Shallow Semantics

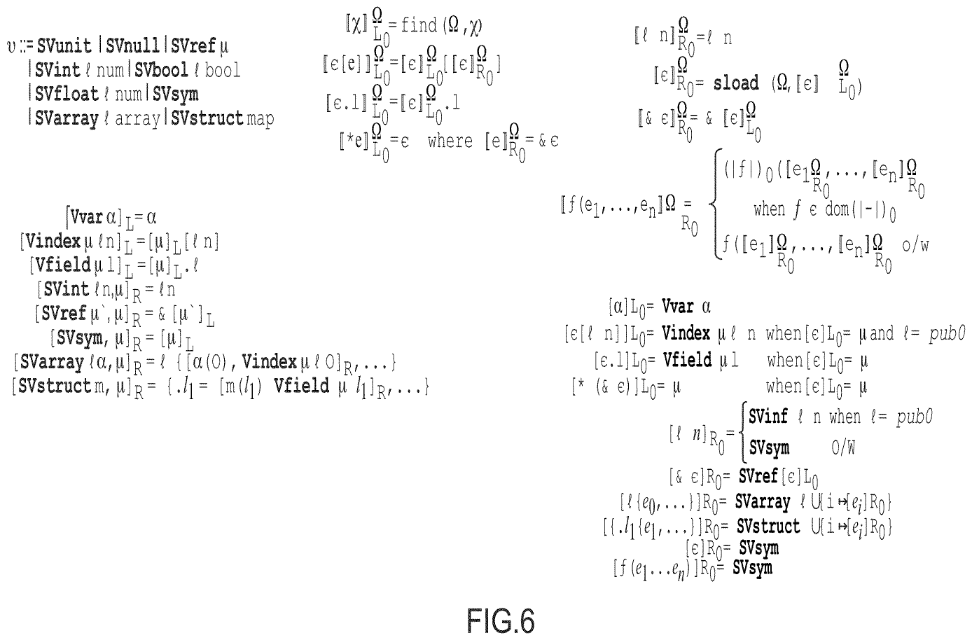

This section formalizes the shallow simulation's behavior as a shallow semantics. FIG. 6 shows its details. The actual implementation uses several optimizations to speed up the simulation.

Symbolic values. To define the semantics of both shallow simulation and deep simulation, symbolic values are defined to represent R-values not known during the simulation. This is done by redefining the R-value constructor from Sec. 3.3 to support SVsym variants, and also by using symbolic stacks, which store symbolic values.

Builtin functions. During shallow simulation only a subset of the builtin functions can be interpreted as the rest rely on either K₁ or K₂ knowledge. (|ƒ|)₀ is used to denote a shallow simulateable interpretation of a builtin function. It takes in a list of expressions and yields an expression as the result. For example, we have the interpretation (|pub0_int_add|)₀(pub0 1, pub0 2)=pub0 3, while pvt1_int_add∈(|−|)₀ as it relies on K₁ knowledge.

Semantics.

$${〚 ϵ 〛}_{{L}_{0}}^{Ω} = {ϵ}^{′}$$

means simplifying an L-expression 6 in a symbolic stack Ω with K₀ knowledge results in an L-expression ϵ′. These semantics simplify an L-expression instead of evaluating it directly, as the stack may not contain enough infornation to fully evaluate it to an L-value. Similarly,

$${〚 e 〛}_{{R}_{0}}^{Ω} = {ϵ}^{′}$$

simplifies an R-expression.

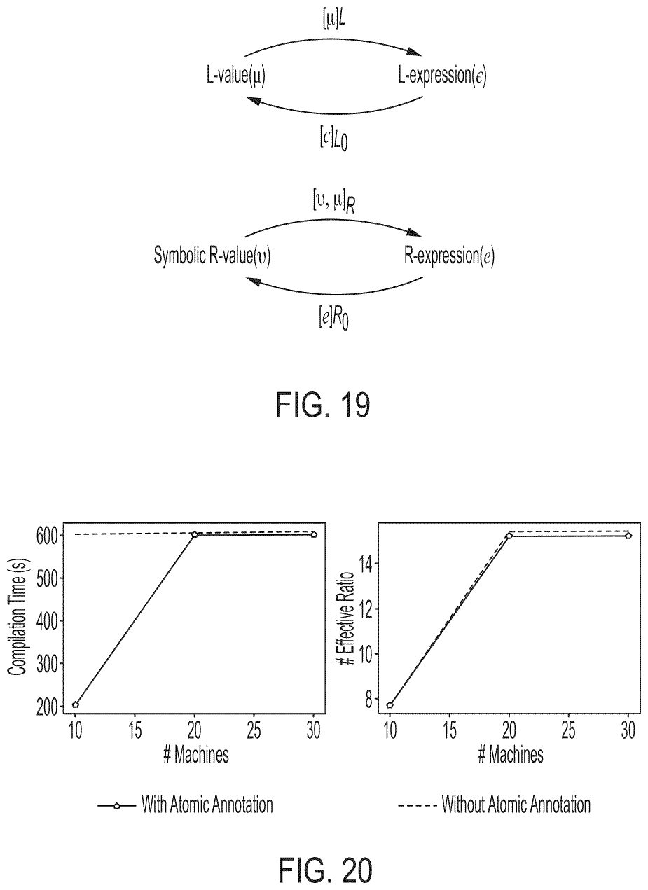

When storing a simplified expression into the stack, a partial function └−┘_{L}_{₀} is used to evaluate an L-expression down to an L-value, and a total function └−┘_{R}_{₀} is used to evaluate an R-expression down to a symbolic R-value. └−┘_{R}_{₀} is able to be total because it replaces all unknown subexpressions by SVsym. When loading a value from the stack, a total function ┌−┐ is used to lift a symbolic L-value to an L-expression, and a total function ┌−,−┐_{R} is used to lift a symbolic R-value to an R-expression and concretize any SVsym variables using the appropriate L-value. See FIG. 19.

Load and store are reused to load and store symbolic values to and from the symbolic stack.

$$sload ( Ω , ϵ ) = \{ \begin{matrix}{⌈ load ( Ω , μ ) ⌉}_{R} & when {⌊ ϵ ⌋}_{{L}_{0}} = μ \\ ϵ & otherwise\end{matrix}$$

$$sstore ( Ω , ϵ , e ) = \{ \begin{matrix}store ( Ω , μ , {⌊ e ⌋}_{{R}_{0}} ) & when {⌊ ϵ ⌋}_{{L}_{0}} = μ \\ Ω & otherwise\end{matrix}$$

When ϵ is not completely known, type wellfoTmnedness guarantees that the symbolic value referred to by it must also be unknown, i.e., SVsym or an array or struct of unknown values. When so the value to be stored must also be unknown, thus sstore behaves correctly even when 6 is not fully evaluated.

Commands: (c, Ω₁) [symbol] _{c}(r, Ω₂, h) means simplifying a command c in a symbolic stack Ω₁ results in: a return status r which is either cont or ret c, a new stack Ω₂, and a sequence history h. • is used to denote an empty history.

Shallow simulation does not have enough knowledge to simulate a sandboxed function, thus it returns a symbolic value generated from the type r. Also, the typing rule guarantees even if a pointer is passed into the function, the pointed data must be filled with SVsym. So no matter whether the function has side effect or not, the symbolic stack remains unchanged.

Note that two pseudo-commands push and pop have been added into the generated program. They help mark the points where a function is called and returned, and their dynamitic semantics are just pushing and poping stacks. Though helpful for the compiler, ignoring them does not change the program's behavior as the alias mechanism guarantees there will never be name conflicts. They are introduced mainly as machinery to help prove refinement.

Atomic function calls. The size of a generated program can be very large as it is linear in the execution time. To reduce the challenge for partitioning, users are allowed to annotate some functions as atomic in order to contract the function call into one command in the generated program. Atomic annotations are optional for programs and are intended solely for optimization purposes. The effectiveness of an atomic annotation depends on the user's understanding of the program structure. If an atomic annotation is inappropriate, it may increase the compilation time, but it will not compromise the program's security.

Their semantics are very similar to normal function calls, but instead of generating a sequence of history, an atomic function call τx=ƒ(e₁, . . . , eₙ) only yields one command in the history:

$$τ α = f ( {e}_{1}^{′} , … , {e}_{n}^{′} ) {RS}_{R} {WS}_{W} .$$

Here, a new kind of command is added to encode atomic function calls, but its dynamic semantics are the same as for normal function calls. The two extra sets S_{R} and S_{W} are only used to help perform live variable analysis.

S_{R} records a set of L-values defined before calling ƒ that may be read during the function call, while S_{W} records a set of L-values defined before calling ƒ that be updated during the function call. They are collected during the simulation using functions from Sec. 5.1: REF(c) computes all L-values that may be read in command c; DEF(c) computes all L-values that may be updated in c.

One convenient fact about shallow simulation is that no pointer dereference will appear in a generated program. It is a corollary of a more essential property: shallow simulation fully evaluates all expressions that only need K₀ knowledge, including all pointers. In Section 10, normalized expressions are defined to formally describe this property to help prove the correctness of shallow simulation,

### 4.2 Correctness of Shallow Simulation

A refinement function [symbol] mapping R-values to symbolic R-values is first defined. It replaces all non-pub0 atomic values with SVsyr. [symbol] is overloaded to also represent the function that performs the transformations to convert a stack into a symbolic stack.

$$ℛ ( Vint ℓ n ) = \{ \begin{matrix}SVint ℓ n & when ℓ = pub 0 \\ SVsym & otherwise\end{matrix}$$

$$ℛ ( Vref μ ) = SVref μ$$

$$ℛ ( Varray ℓ a ) = SVarray ℓ ⋃ \{ i ↦ ℛ ( a ( i ) ) \}$$

$$ℛ ( Vstruct m ) = SVstruct ⋃ ( {l}_{i} ↦ ℛ ( m ( {l}_{i} ) ) \}$$

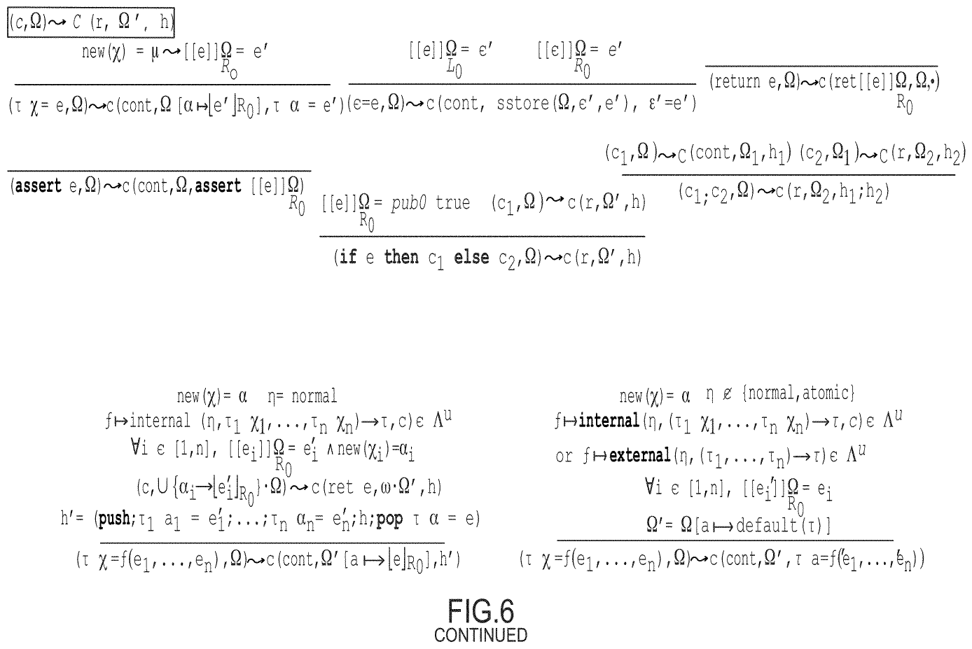

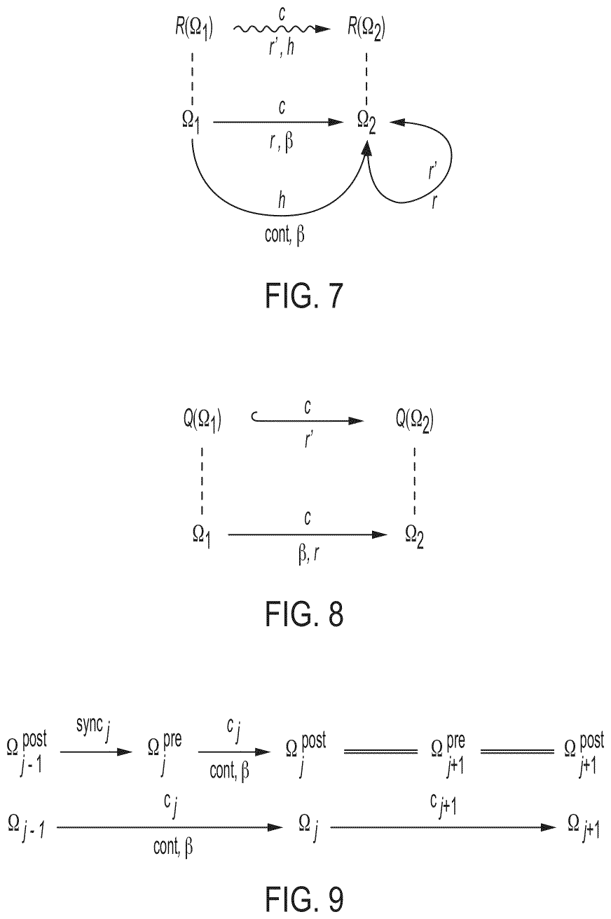

See FIG. 7. A semantics

$${〚 r 〛}_{\underline{R}}^{Ω}$$

is also defined in order to evaluate return statuses.

$$\begin{matrix}{〚 cont 〛}_{\underline{R}}^{Ω} = cont & {〚 ret e 〛}_{\underline{R}}^{Ω}\end{matrix} = {ret 〚 e 〛}_{R}^{Ω}$$

$$THEOREM 1. If ( c , {Ω}_{1} ) {\to }_{C} ( r , {Ω}_{2} , β ) , then there exist {r}^{′} and h s . t .$$

$$( c , ℛ ( {Ω}_{1} ) ) {\text{?}}_{C} ( {r}^{′} , ℛ ( {Ω}_{2} ) , h )$$

$$and ( h , {Ω}_{1} ) {\to }_{C} ( cont , {Ω}_{2} , β ) {and 〚 {r}^{′} 〛}_{\underline{R}}^{Ω} = r .$$

FIG. 7 demonstrates this theorem. Although shallow simulation reorders some computations by simplifying K₀ expressions and unfolding the program, this theorem guarantees such reordering does not change the behavior. The theorem is proved in Section 10.2.

### 5. Statement Partitioning

The shallow simulation unfolds the original program into a sequential program h=c₁; . . . ; cₙ. The compiler then tries to find an optimal way to partition these commands into i chunks so that the distributed running time and the communication time are minimized. Sec. 5.1 describes the live variable analysis algorithm that finds data dependencies in the sequential program. Sec. 5.2 then describes how DZKP encodes the cut search problem and uses a solver to find the efficient partition. Sec. 5.3 then explains how we generate the distributed program from the sequential program, the partition, and the dependencies.

### 5.1 Live Variable Analysis

DZKP performs live variable analysis on a sequential program h=c₁; . . . ; cₙ. The goal is to generate a dependency graph DG=(DV, DE) where DV={1 . . . n} and each edge (i,j)∈DE is decorated with a set of L-values DEP(i, j) that may be read in cⱼ and may be manipulated in cᵢ. The term ‘may’ is used rather than ‘will’ because shallow simulation cannot determine all L-expressions' values. Nonetheless, an over-approximate analysis can still be conducted using some approximation functions. Note DEP(i, j) is only meaningful when i<j, so DEP(i, j)=Ø when i≥j.

Section 11 defines two utility functions: REF(c) computes the set of L-values that nay be read in c, while DEF(c) computes the set of L-valtues that are newly defined or may be updated in c. Recall that these functions are used in Sec. 4.1.

Analysis Algorithm. The program is a sequence of commands h=c₁; . . . ; cₙ. Live variable analysis starts from its end and LIVE(n):=0. It is then scanned from the end to the beginning and unresolved dependent variables are computed for each command cᵢ.

$$LIVE ( i - 1 ) = \{ μ ↦ j ∈ LIVE ( i ) \vert μ ∉ DEF ( {c}_{i} ) ⋃ REF ( {c}_{i} ) \}$$

$$⋃ \{ μ ↦ i \vert μ ∈ REF ( {c}_{i} ) \}$$

LIVE(i) is a mapping from L-values to the commands that may read them in the future. If cᵢ uses an L-value,² then it can safely be deleted from LIVE(i) and that L-value can be added as a dependency between cᵢ and cⱼ. However, cᵢ may read other L-values, so all L-values from REF(cᵢ) need to be marked as unresolved and dependent on cr. Such dependencies will eventually be resolved because every L-value is part of a variable defined in the program, and the command that defines the variable cannot read it. Now the graph DG can be constructed by defining the dependency function.

$$DEP ( i , j ) = \{ μ \vert μ ↦ j ∈ LIVE ( i ) ⋀ μ ∈ DEF ( {c}_{i} ) ⋃ REF ( {c}_{i} ) \}$$

In order to capture all dependencies of and from a command

$$DEP ( i , - ) := {U}_{j = 1}^{n} DEP ( i , j ) and ( - , j ) := {U}_{i = 1}^{n} DEP ( i , j )$$

are denoted. It follows from the definition that DG is a directed acyclic graph, i.e., i≥⇒DEP(i,j)=0.

A notion of similarity between stacks need to be defined to reason about the correctness of live variable analysis and program distribution. Given two stacks Ω₁ and Ω₂ and a set of L-values S, it is said flr and D2 are similar up to S, denoted as Ω₁≈s Ω₂, if (1) ∀μ∈S, load(Ω₁,μ)=load(Ω₂,μ), and (2) the two stacks have similar structures in terms of S, i.e. every alias appearing in S resides in the same frame in both stacks. ² in traditional live variable analysis, a live variable is only resolved when it is modified or defined, but here we also resolve it when it is read. This is a compromise to simplify the optimal cut search and to reduce cutting cost in most eases. See Appendix D.

Theorem 2 shows the live variable analysis is correct it says the dependent L-values of cⱼ are enough to safely execute the command and yield all values that are dependent later. It can be proven by observing DEP(j, −)⊆DEF(cⱼ)∪REF(cⱼ) and DEP(−,j) REF(cⱼ), then proving the values in REF(cⱼ) are enough for cⱼ to execute and produce the desired behavior.

$$Theorem 2. If both ( {c}_{1} ; … ; {c}_{j - 1} , Ω ) {\to }_{C} ( cont , {Ω}_{j - 1} , {β}_{j - 1} ) and$$

$$( {c}_{j} , Ω ) {\to }_{C} ( cont , {Ω}_{j} , {β}_{j} ) then$$

$$∀ {Ω}_{j - 1}^{′} , {Ω}_{j - 1} {\approx }_{DEP ( - , j )} {Ω}_{j - 1}^{′} ⟹ ∃ {Ω}_{j}^{′} , ( {c}_{j} , {Ω}_{j - 1}^{′} ) {\to }_{C} ( cont , {Ω}_{j}^{′} , β ) ⋀ {Ω}_{j} {\approx }_{DEP ( j , - )} {Ω}_{j}^{′}$$

### 5.2 Optimal Cut Search

The final intermediary pass of the compilation partitions the program into k chunks for parallel execution. Recall that after the flattening during shallow simulation (Sec. 4) and the live variable analysis (Sec. 5-1), DZKP obtains a sequential program h=c₁; . . . ; cₙ and a dependency graph DG=(DV, DE) where each edge (i, j) in DE is decorated with a set of dependent L-values DEP(i, j). The compiler then extracts a directed acyclic graph G=(V, E) from DG capturing the dependency relation and the costs. Each node i in V is decorated with cᵢ's computation cost PCᵢ. An edge (i, j)∈E indicates cⱼ reads at least one L-value used last by cᵢ, and is decorated with the communication cost Cᵢⱼ and a cuttable bit Bᵢⱼ. If there is a. K₂ F-value in DEP(i, j), then cᵢ and cⱼ must reside in the same chunk, thus Cᵢⱼ=∞ and Bᵢⱼ=0; Otherwise, Cᵢⱼ equals to the accumulated cutting cost of all K₁ L-values in DEP(i, j) and Bᵢⱼ=1.

Combinatorial optimization constrained by G is used to find the optimal cutting of h into k chunks

$$〈 {h}_{1}^{sub} , {h}_{2}^{sub} , … , {h}_{κ}^{sub} 〉 .$$

This optimization problem is natively written as an integer linear program (ILP) However, the variables (though not the constants) it uses are all Booleans, and therefore the objective can be interpreted as a pseudo-Boolean function and optimized using pseudo-Boolean optimization (PBO) as well.

Initially,

$$ub = log ( {\sum }_{i = 1}^{n} {PC}_{j} ) ,$$

the length of the cost of the sequential computation, is defined. Next a pair of matrices is defined. Y∈{0, 1}^{n×n}, indicates the location of cuts: Yᵢⱼ=1 means that a cut is made between the i-th and j-th instruction block. X∈{0, 1}^{n×k} indicates the inclusion of instruction blocks into partitions: Xᵢₜ=1 indicates the i-th instruction is in the t-th partition for t∈[k].

Finding the cheapest partitioning then reduces to solving the optimization objective of

$$obj ( G ) = {min}_{X , Y} [ {\sum }_{( i , j ) ϵ E} {Y}_{ij} \cdot {C}_{ij} + {max}_{t ∈ [ κ ]} {\sum }_{i = 1}^{n} {X}_{it} \cdot {PC}_{i} ]$$

subject to some consistency constraints on X and Y, In order to soundly model this problem for constrained optimization without a min-max objective requires, for PBO in particular, a bit of due care. The present approach is described below:

$$min {\sum }_{i = 1}^{ub} {2}^{( i - 1 )} \cdot {COP}_{i} + {\sum }_{e ϵ E} {C}_{e} \cdot {Y}_{e}$$

$$s . t . \begin{matrix}∀ i ∈ [ n ] : & {\sum }_{t = 1}^{κ}\end{matrix} {X}_{it} = 1$$

$$∀ ( i , j ) ∈ E : \qquad {Y}_{ij} \leq {B}_{ij}$$

$$∀ ( i , j ) ∈ E , t ∈ [ κ ] : \qquad {X}_{it} + {X}_{jt} \leq 2 - {Y}_{ij}$$

$$∀ ( i , j ) ∈ E , t ∈ [ κ ] : \qquad \vert {X}_{it} - {X}_{jt} \vert \leq {Y}_{ij}$$

$$∀ t ∈ [ κ ] : \qquad {\sum }_{ℓ = 1}^{ub} {2}^{( ℓ - 1 )} \cdot {COP}_{ℓ} + {\sum }_{i = 1}^{n} {X}_{it} \cdot {PC}_{i}$$

$$\begin{matrix}∀ i ∈ [ n ] , t ∈ [ κ ] : & {X}_{it}\end{matrix} ∈ \{ 0 , 1 \}$$

$$\begin{matrix}∀ ( i , j ) ∈ E : & {Y}_{it}\end{matrix} ∈ \{ 0 , 1 \}$$

$$\begin{matrix}∀ ℓ ∈ [ ub ] : & {COP}_{ℓ}\end{matrix} ∈ \{ 0 , 1 \}$$

The first constraint enforces that every instruction appears in exactly one partition, the second that only cuttable edges are cut, and the third and fourth together that if the i-th and I-th instruction blocks are in different partitions, then any edge (i, j) must be represented in the appropriate cut by Yᵢⱼ. The final four constraints simply enforce the Boolean character of the variables.

The fifth constraint is the most nuanced. It enforces that

$${COP}_{i} = the i - th bit of \begin{matrix}max \\ t ∈ [ κ ]\end{matrix} {\sum }_{i = 1}^{n} {X}_{it} \cdot {PC}_{i}$$

so that the computation in the objective function is correct. This relationship can be encoded much more simply in a general ILP, but is necessary for PBO compatibility. Notice that no constraints force the partitions to be contiguous: even though h is a sequential program, the

$${h}_{t}^{sub}$$

can have a much more complex structure, at the cost of additional extended witnesses and so more communication during the consistency checking.

With this encoding, DZKP hands this optimization problem to either a PBO or ILP solver (the Gurobi PBO solver is used in the present benchmarks). The solver's output may not always be optimal in practice, as it is limited by the available computational resources. Consequently, the corresponding cut scheme that is employed may also be suboptimal. The compiler then converts the result into a function chunk(−) such that chunk(i)=t if Xᵢₜ=1 in the solver's result.

$$chunk ( i ) \neq chunk ( j ) ⟹ no {K}_{2} L - value in DEP ( i , j ) \qquad FACT 1.$$

This follows directly from the PBO constraints.

### 5.3 Distributed Program

Given a sequential program h=c₁; . . . ; cₙ from the shallow simulation, a dependency graph DEP(−, −) from live variable analysis, and a partition chunk(−) from optimal cut search, the compiler generates K programs for distributed execution among K pairs of prover and verifier computation cores.

The t-th chunk is a sequential program syncₜ_{₁}; cₜ_{₁}; syncₜ_{₂}; cₜ_{₂}; . . . such that t=chunk(t₁)=chunk(t₂)= . . . and t₁<t₂ . . . . A communication between the prover and the verifier is denoted by syncₜ_{ⱼ}. These communication rounds are used to share K₀ or authenticate K₁ data that are needed by cₜ_{ⱼ}, i.e., data pointed by L-values in U_{chunk(i)≠t}DEP(i, tⱼ), as necessary. Deep simulation (Sec. 6) computes all this dependent data and distribute it to all of the prover cores. So each pair of prover core and verifier core can run their chunk without the others' involvement. At the end, all verifier cores will work together to do a consistency check. The goal is to make sure all data provided by the prover cores in syncₜ_{ⱼ} are indeed the same as produced by their dependent commands in other chunks. Note the deep simulation only computes K₀ and K₁ values, but Fact 1 guarantees all data needed for multipole chunks does not contain K₂ information, thus the deep simulation is enough.

### 6. Deep Simulation

The deep simulation executes the program with K₀ and K₁ knowledge and evaluates all K₀ and K₁ values. The goal is to compute all data that are depended between different chunks in the distributed program. It is similar to shallow simulation, except that (i) the definitions of all external functions are known, (ii) the knowledge level is K₁ instead of K₀, and (iii) the purpose is to evaluate all K₀ and all K₁values instead of unfolding the program.

### 6.1 Deep Semantics

This section formalizes deep simulation as a deep semantics. The same symbolic values and stacks are used as in Sec. 4.1. ┌−, −┐_{R} and ┌−┐_{L} are still used to lift R-values and L-values to R-expressions and L-expressions. But when converting in the reversed direction, └−┘_{R}, and └−┘_{L}_{₁} are used instead of └−┘_{R}_{₀} and └−┘_{L}_{₀}. The only difference is when converting atomic expressions. For example, └ [symbol] n┘_{R}_{₁}=SVint [symbol] n when [symbol] ≤plc1. dhoad and dstore are also defined based on these operations just like sload and sstore.

The semantics for L-expressions

$${〚 ϵ 〛}_{{L}_{1}}^{Ω}$$

### and R-expressions

$${〚 e 〛}_{{R}_{1}}^{Ω}$$

are also similar except for using └−┘_{L}_{₁} and └−┘_{R}_{₁} to interact with the symbolic stack, allowing dereference expression to be not fully evaluated, and use (|ƒ|)₁ to interpret builtin functions. (|−|)₁ is a superset of (|−|)₀ by adding more functions that can be computed with K₁ knowledge. For example (|pvt1_int_add|)₁(pvt1 n, pvt1m)=pvt1(n+n). Section 12 has their detailed definitions.

Commands' semantics is also similar. (c, Ω₁) [symbol] _{c}(r, Ω₂) means running command c from stack Ω₁ results in a return status r which is either cont or ret e and a new stack Ω₂. Note it no longer generates a history as the purpose of the deep simulation is merely computing K₀ and K₁ values. Also, it executes normal, atomic, plocal1 and box1 functions while ignores plocal1 and box2. The detailed rules are in Section 12.

### 6.2 Correctness of Deep Simulation

Similar to shallow simulation, a refinement function Q that converts R-values to symbolic R-values is defined. This time only all values with pub2, pvt2 and plc2 security levels are turned into SVsym. This function is also overridden to apply on stacks

$$If ( c , {Ω}_{1} ) {\to }_{c} ( r , {Ω}_{2} , β ) then there exists {r}^{′} where \qquad THEOREM 3.$$

$$( c , Q ( {Ω}_{1} ) ) {\text{?}}_{c} ( {r}^{′} , Q ( {Ω}_{2} ) ) {and 〚 {r}^{′} 〛}_{\underline{R}}^{{Ω}_{2}} = r$$

FIG. 8 demonstrates this theorem. The proof is very similar to theorem 1 as their semantics are similar except for the deep semantics is a bit simpler.

### 6.3 Correctness of Distribution

Sec. 5.3 shows the distributed program, and Sec. 6.1 evaluates all dependent data that are needed in the sync steps. It is now proved that these data are sufficient for the distributed program to terminate with the same behavior as if running without distribution.

Given a sequential program c₁; . . . ; cₙ generated by the shallow simulation and an initial stack Ω₀, suppose the program runs like (c₁, Ωᵢ₋₁)→_{c}(cont, Ωᵢ, βᵢ) without cutting. The focus is on the t-th chunk and aligning its execution like in FIG. 9. Each command cⱼ corresponds to two stacks

$${Ω}_{j}^{pre} and {Ω}_{j}^{post} .$$

If chunk(j)=t, syncⱼ is first run to add external dependent values into

$${Ω}_{j - 1}^{post} ,$$

then cⱼ is run; Otherwise, the stack remains unchanged.

It needs to be proven that the following theorem holds, then theorem 2 ensures that cⱼ terminates with the same behavior.

$$∀ j ∈ {chunk}^{- 1} ( t ) , {Ω}_{j}^{pre} {\approx }_{S} {Ω}_{j - 1} where S = DEP ( - , j ) . \qquad Theorem 4.$$

In Section 13, this theorem is proven by first defining a set of L-values

$${ϕ}_{j}^{t}$$

that are internally dependent in the t-th chunk after cⱼ, then proving the stack in the uncut execution is always similar to the t-th chunk's local stack up to this set. So the internal dependency is handled, theorem 3 is then used to handle the external dependency happening in sync, combining them together proves the theorem.

### 7. Evaluation

### 7.1 Evaluation Setup and Metrics

Three metrics are used to evaluate the effectiveness of the present tool:
Compilation Time is the time used for shallow simulation, data dependency analysis, and optimal cut search. PBO solving during the compilation is done via the Gurobi (L Gurobi Optimization. 2020. Gurobi Optimizer Reference Manual (2020).) PBO solver. The time cost of deep simulation is not included in the compilation time, but deep simulation takes less than 0.5% of the compilation time for all examples.
Effective Ratio of a distributed zero knowledge program is defined as the quotient of the cost of the sequential execution (total costs of all instructions) by the cost of the distributed execution (as the objective function in Sec. 5). When a program is distributed to x chunks, the closer the effective ratio is to i, the better the distribution scheme is. It is noted that the optimal effective ratio may be smaller than k, depending on the statement.
Execution Time refers to the end-to-end performance. Ou code is compiled to a VOLE-based ZK implementation (EMIP (Xiao Wang, Alex J. Malozemoff, and Jonathan Katz. 2016. EMP-toolkit: Efficient MultiParty Computation Toolkit.)) and measure the execution time of the resulting distributed programs. VOLE-based ZK backend was selected as one of the motivations is to work with large-scale applications. This choice allows handling of large statements without requiring costly machines with large memory. In addition, the present implementation can be easily extended to support a rich set of ZK protocols, since EMP can be connected to SIEVE-IR (the DARPA SIEVE Program. 2022. SIEVE Intermediate Representation).

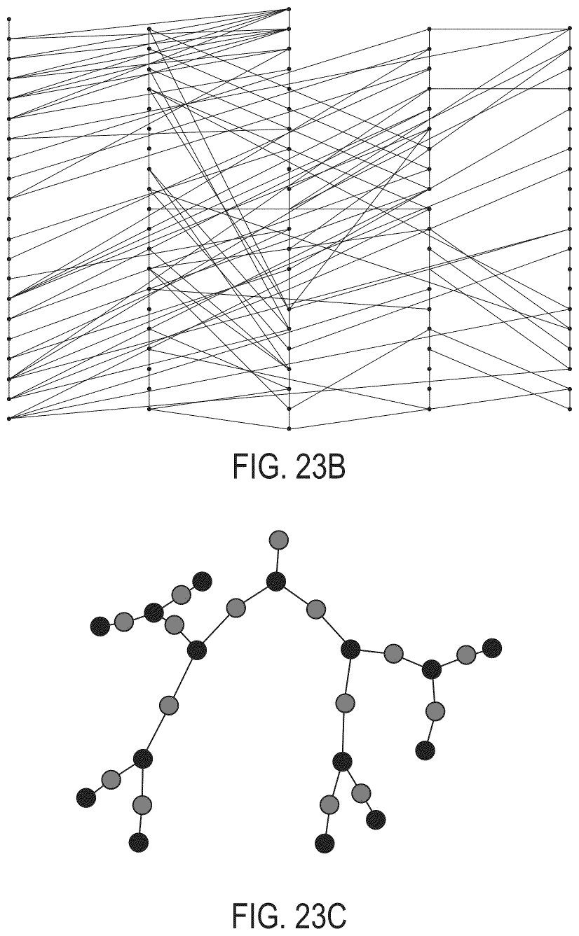

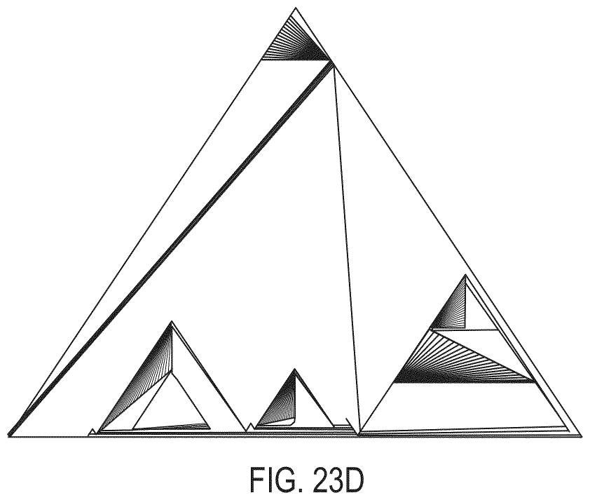

To evaluate the present tool, two programs with different features were focused on. All implementations in the present language Ou can be found in the supplementary material. As the effectiveness of DZKP also depends on the structure of the input program, further provided is a beautiful visualization for the program structure of gradient descent and merkle tree in FIGS. 23A-D.
(1) Gradient descent (GD) is an optimization algorithm for finding the optimal model in machine learning. It works by iteratively updating the parameters of a model in the direction of the negative gradient of the cost function concerning those parameters. Gradient decent is implemented for logistic regression with 10 features.
(2) Merkle tree (MT) is a type of data structure used to verify the integrity of large amounts of data. It breaks the data into smaller blocks, then recursively hashes each pair of blocks to create a new set of parent nodes using a cryptographic hash function. By proving the correct computation of the Merkle tree, the prover can prove they have the original data without revealing the actual data to the verifier (Ralph C. Merkle. 1987. A Digital Signature Based on a Conventional Encryption Function. In CRYPTO (Lecture Notes in Computer Science, Vol. 293). Springer, 369-378.).

### 7.2 Evaluation of the Partition Quality

First, it is demonstrated that the changes in the effective ratio of the distribution scheme found by DZKP for (i) and MTI program changes with the size of programs and the number of cuts. GD takes a set {(x, y)} as input, where x is a vector of size M. Throughout this section, |{(x, y)}| is fixed to be 20 and |x| is fixed to be 10.

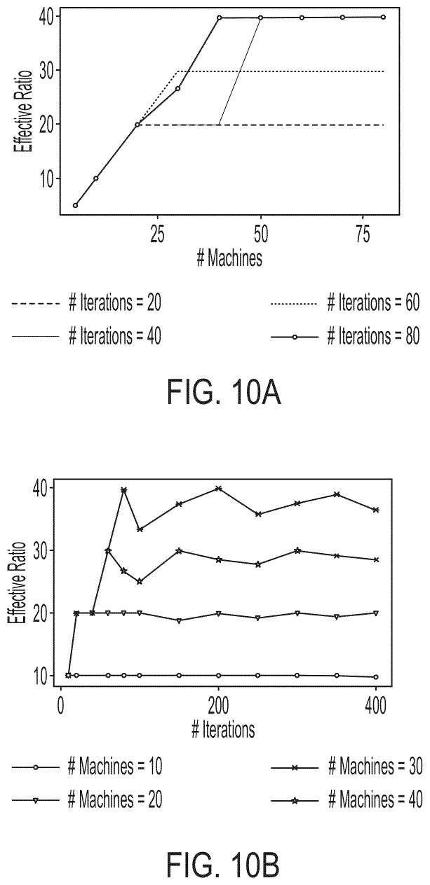

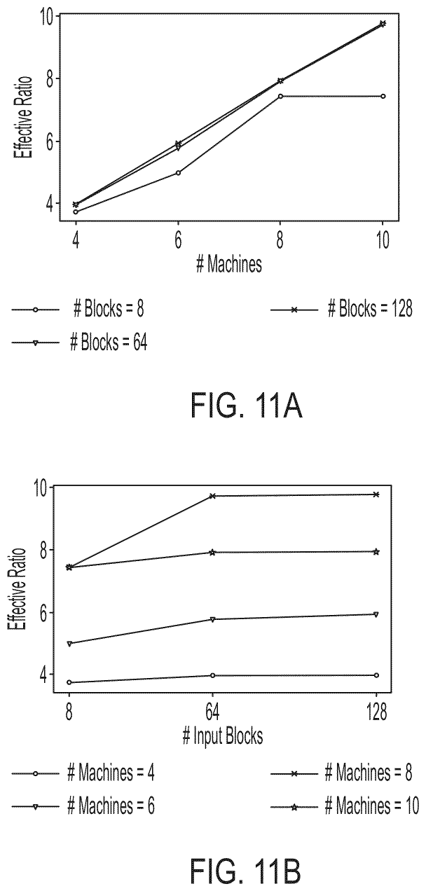

The effective ratio of DZKP is affected by the length of the program being distributed. The length of GD and MT programs are decided by the number of iterations and the number of input blocks, respectively. As shown in FIGS. 10B and 11B, DZKP can find the distribution scheme that achieves the almost optimal effective ratio for large programs for both GD and MT cases.

FIGS. 10A and 11A demonstrate that the effective ratio will increase with the number of machines rising when the number of partitions is relatively small. Moreover, the results present an upper bound of the effective ratio of the distribution scheme for a given program. For example, the effective ratio for the GD programs involving 80 iterations reaches 40 and stays unchanged regardless of the increasing number of machines. Nevertheless, the results show that our tool can utilize a high degree of parallelization.

### 7.3 Effectiveness of Atomic Annotation

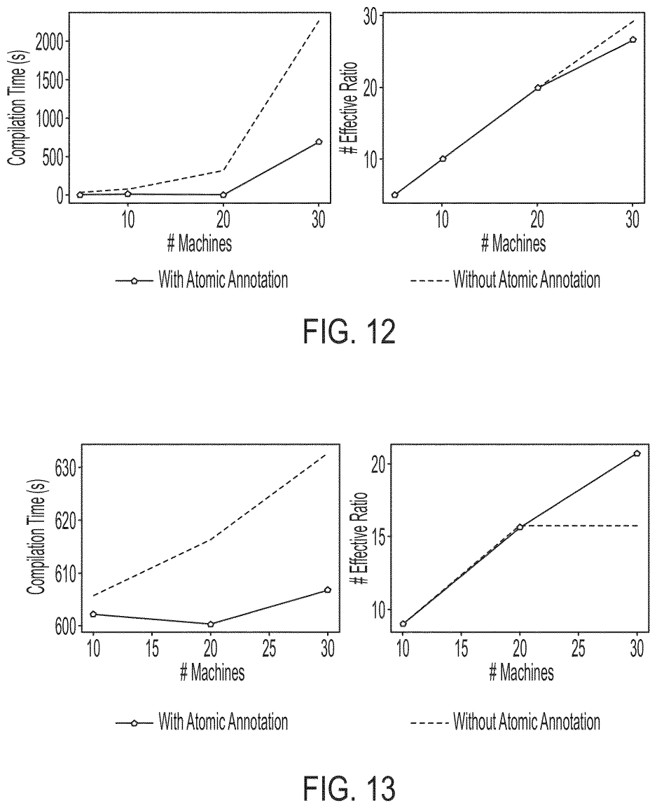

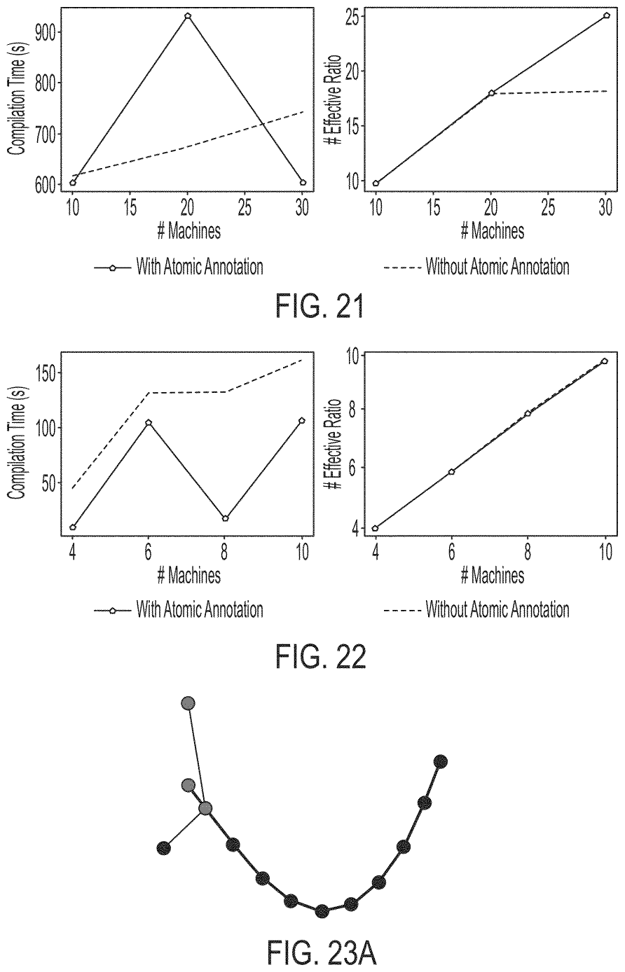

In this section, the impact of annotation to the compilation time and effective ratio is studied. For all examples, the time limit of the PBO solver is set to 10 minutes. In the program for G D, there is a function called update_all( ). This function updates the model's parameter using all data points and is called for each iteration. There is a function called sha256_node( ) that computes the hash of internal blocks in the MT program. The compilation time and effective ratio of GD programs (or MT programs) are compared with and without update_all( )(or sha256_node( ) being atomic while changing K and the number of iterations (FIGS. 12-13 and 20-22).

The results of the evaluation show that the effects of adding atomic annotations depend on the structure of the programs. FIGS. 12 and 13 show a significant rise in the compilation efficiency when adding annotation for both GD and MT programs. The compilation time decreases by 1X to 60X with K and the number of iterations varying. The price of efficient compilation is a reduction in the effective ratio. The effective ratio for the annotated program is smaller than the unannotated one for GD programs: adding atomic annotation rules out a part of feasible solutions which may contain the optimum.

Sometimes, adding annotation could even improve the effective ratio, especially when the constrained time is far less than what is needed to search for an optimal partition. FIG. 13 demonstrates an example of this case. The effective ratio is measured while setting the time limit of the PBO solver to 600 seconds. The effective ratio of the MT program for 32-block input with annotation is even better than the one without annotation when the number of cuts increases. One reason behind this result is the NIT program structure. The solution found for the annotated program is also optimum for the unannotated one. Furthermore, with a part of the functions being atomic, the search space of the PBO solving essentially shrinks. For additional information, the results of MT programs for various input sizes are included in the sections below.

### 7.4 End-to-End Running Time

The present implementation is end-to-end: it can compile an Ou program to K pieces of EMP circuits. Most of the compiler's implementation is not tied to EMP, so it is flexible to connect with other backends.

The running time of the distributed circuits generated from GD and MT is tested herein. The testing machine is an AWS m5.large instance with 2vCPU and 8 GB memory. For GD, the number of dataset is fixed to be 10, the size of each dataset is fixed to be 100 and iterate 200 rounds. For MT, the data length is fixed to be 256. Table 1 shows with different number of machines, the slowest part's running time and the overall speedup comparing to uncut execution time. The effective ratio estimated by the solver is also listed. For GD, the effective ratio approximates the real speedup very well; For MT, the effective ratio becomes inaccurate as each chunk's runtime reduces. Without wishing to be bound by theory, it is believed that the reason is mainly because the underlying circuits need a constant setup time (around 4 seconds). After subtracting it, the speedup becomes close to the effective ratio.

TABLE 1
End-to-end running time of the framework.

| κ | 1 | 5 | 10 | 20 | 40 |
|---|---|---|---|---|---|
| runtime GD | 681.55 s | 147.91 s | 71.23 s | 38.06 s | 21.90 s |
| runtime speedup GD | 1 | 4.6 | 9.57 | 17.9 | 31.12 |
| effective ratio GD | 1 | 4.99 | 9.95 | 199 | 39.8 |
| runtime MT | 40.23 s | 11.08 s | 7.63 s | 6.5 s | 5.25 s |
| runtime speedup MT | 1 | 3.63 | 5.27 | 6.19 | 7.66 |
| effective ratio MT | 1 | 4.95 | 9.75 | 19.47 | 38.63 |

### 8. Appendix A—Example

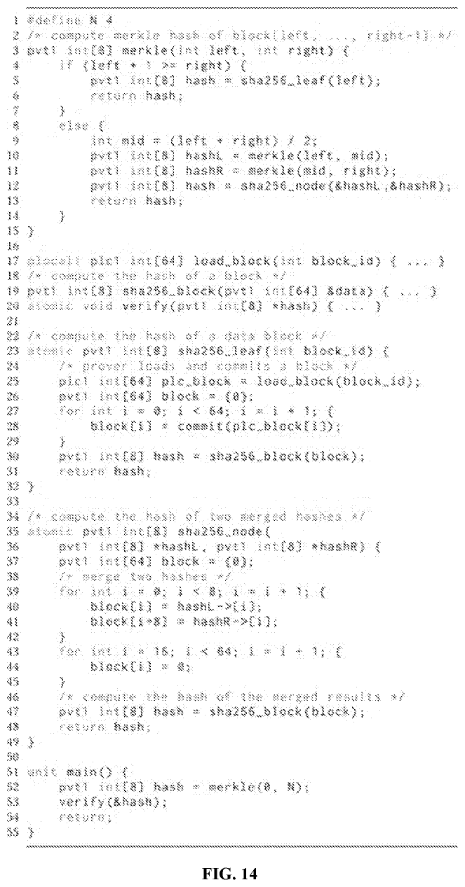

FIG. 14 shows a code snippet of the Merkle tree used in the benchmark. The prover uses a binary Merkle tree to compute the hash of N private data blocks. The merkle function computes the hash of a segment of data blocks. Then the verifier calls verify to verify the hash. When the tree is a leaf node, merkle calls sha256 leaf to fetch a data block and hash it; When the tree is a non-leaf node, merkle recursively computes its two subtrees' hashes, then use sha256_node to compute the merged hash. Suppose the user wants to cut it into 2 fragments, and there are 4 data blocks.

Here sha256 node and sha256 leaf are annotated as atomic, and load block is annotated as plocal1. So during the shallow simulation, sha256_node and sha256 leaf will not be unfolded, and load_block will be ignored during the shallow simulation and executed during the deep simulation.

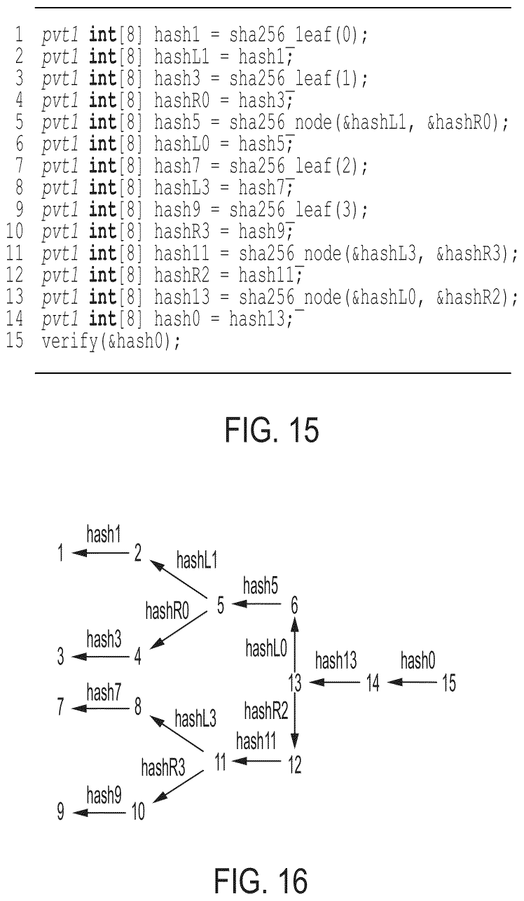

Shallow simulation executes the program with K₀ knowledge, yielding a sequence as FIG. 15. The recursive function merkle is unfolded. Each variable is annotated with a unique number to distinguish it from others with the same name. Line 1-5 computes the hash of data block 0 and 1, line 6-11 computes the hash of data block 2 and 3, line 13-14 merges them, then line 15 verifies it.

Notice in line 4, the recursion condition is a pub0 expression. This is necessary for the unfolding to proceed during the shallow simulation phase. If there is any non-pub0 expression involved in deciding the control flow, then 1) the shallow simulation does not have enough knowledge to evaluate that expression so it cannot decide which branch to take, and 2) even if it uses the prover's knowledge to evaluate that expression, the information will be leaked to the verifier via the generated programs.

Then live variable analysis generates a dependency graph as in FIG. 16. The ILP/PBO solver decides to cut it between lines 5 and 6, so the only dependency is hasb5.

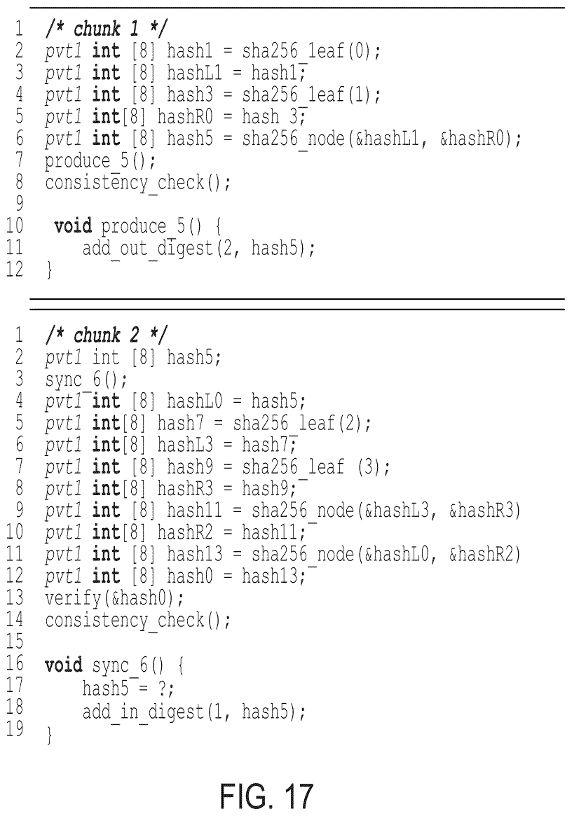

Now the compiler can already generate two programs as in FIG. 17. The produce and sync functions are only shown here. Note produce_5 in chunk 1 records a digest of all variables that are produced by FIG. 15's line 5 for consistency check in the end. Here it is hash5. Similarly, sync_6 records a digest of all variables dependent by FIG. 15's line 6 after assigning values to them, But hash5's value is not known yet, so it is marked using a question mark. The code can already be distributed to individual verifiers, who will count on the provers to supply encrypted hash5 during the runtime. But the provers need to know these values before interacting with the verifiers. So they perform deep simulation on FIG. 15's program based on the secret input and find out hash5's value when reaching line 5.

Here the type system again guarantees the deep simulation can proceed. For example, suppose there is any K₂ value that is dependent between two chunks, and it relies on the verifier's randomness, then the prover at the compile time cannot guess this value, thus it cannot proceed.

In the end, chunk 1 and chunk 2 can run in parallel without any communication. When both chunks' execution finish, they will run a consistency check together to make sure the hash5 used in chunk 2 is indeed produced by chunk 1's execution.

Here the live variable analysis can be seen and the cut-searching should find the minimal dependency between the two chunks that guarantees the safe execution of both. Suppose the live variable analysis fails to determine that hash5 is the dependency between chunk 1 and chunk 2, then chunk 2's line 4 will fail. Suppose the cut-searching algorithm considers hashl, hash3 and hash5 are all needed by chunk2, then more data needs to be committed in sync_6, which will slow down the runtime performance.

### 9. Appendix B—Detailed Semantics

$$( ( {c}_{1} ; {c}_{2} ) ; {c}_{3} , Ω ) {\to }_{c} ( r , {Ω}^{′} , β ) ⇔ ( {c}_{1} ; ( {c}_{2} ; {c}_{3} ) , Ω ) {\to }_{c} ( r , {Ω}^{′} , β ) . \qquad Fact 2.$$

### Proof.

(1) Suppose that (c₁, Ω)→_{c}(ret v, Ω₁, β). Then (c₁; c₂, Ω)→_{c}(ret v, Ω₁,β), so ((c₁; c₂); c₃, Ω)→_{c}(ret v, Ω₁, β). It follows as well that (c₁;(c₂;c₃), Ω)→_{c}(ret v, Ω₁, β).
(2) Suppose both that (c₁, Ω)→_{c}(cont, Ω₁, β₁) and (c₂, Ω₁)→_{c}(ret v, Ω₂, β₂). Then (c₁; c₂, Ω)→_{c}(ret v, Ω₂, β₁·β₂), so ((c₁; c₂)c₃, Ω)→_{c}(ret v, Ω₂, β₁·β₂). Also (c₂; c₃, Ω₁)→_{c}(ret v, Ω₂, β₂), so (c₁; (c₂;c₃), Ω)→_{c}(ret v, Ω₂, β₁·β₂).
(3) Suppose (c₁, Ω)→_{c}(cont, Q₁, β₁), (c₂, Ω₁)→_{c}(cont, Ω₂, β₂) and (c₃, Ω₂)→_{c}(r, Ω₃, β₃). Then (c₁; c₂, Ω)→_{c}(cont, Ω₂, β₁·β₂), so ((c₁; c₂); c₃, Ω)→_{c}(r, Ω₃, β₁·β₂. It follows as well that (c₂; c₃, Ω₁)→_{c}(r, Ω₃, β₂·β₃), so (c₁;(c₂; c₃), Ω)→_{c}(r, Ω₃, β₁·β₂·β₃).

### 10. Appendix C—Detailed Shallow Simulation

### 10.1 Shallow Semantics

Here are some rules riot listed in the main content,

$$\frac{( {c}_{1} , Ω ) {\text{?}}_{c} ( ret e , {Ω}_{1} , h )}{( {c}_{1} ; {c}_{2} , Ω ) {\text{?}}_{c} ( ret e , {Ω}_{1} , h )}$$

$$\frac{{〚 e 〛}_{{R}_{0}}^{Ω} = pub 0 false ( {c}_{2} , Ω ) {\text{?}}_{c} ( r , {Ω}^{′} , h )}{( if e then {c}_{1} else {c}_{2} , Ω ) {\text{?}}_{c} ( r , {Ω}^{′} , h )}$$

$${〚 e 〛}_{{R}_{0}}^{Ω} = pub 0 true$$

$$\frac{( c ; while e do c , Ω ) {\text{?}}_{c} ( r , {Ω}^{′} , h )}{( while e do c , Ω ) {\text{?}}_{c} ( r , {Ω}^{′} , h )}$$

$$\frac{{〚 e 〛}_{{R}_{0}}^{Ω} = pub 0 false}{( while e do c , Ω ) {\text{?}}_{c} ( cont , Ω , \cdot )}$$

Here's the dynamic semantics of the two new commands:

$$\frac{}{( push , Ω ) {\to }_{c} ( cont , 0 \cdot Ω , <> \cdot )}$$

$$\frac{{〚 e 〛}_{R}^{ω \cdot Ω} = v}{( pop τ α = e , ω \cdot Ω ) {\to }_{c} ( cont , Ω [ α ↦ v ] , <> )}$$

As with the dynamic semantics, it can be shown that command concatenation is associative.

$$S ( ( {c}_{1} ; {c}_{2} ) ; {c}_{3} , Ω ) {\text{?}}_{c} ( r , {Ω}^{′} , h ) ⇔ ( {c}_{1} ; ( {c}_{2} ; {c}_{3} ) , Ω ) {\text{?}}_{c} ( r , {Ω}^{′} , h ) . \qquad FACT 3.$$

The proof is similar to Fact 2.

An R-expression e (or L-expression ϵ) is said to be normalized in a symbolic stack Ω, denoted as rnorm(Ω,e) (or lnorm(Ω,ϵ)), if all its sub-expressions cannot be further simplified,

| | | |
|---|---|---|
| Inorm(Ω,α) | | |
| Inorm(Ω,ϵ [e]) | if | Inorm(Ω, ϵ) ∧ morm(Ω, e) |
| Inorm(Ω, ϵ.l) | if | Inorm(Ω, ϵ) |
| morm(Ω, [symbol] n) | | |
| morm(Ω, & ϵ) | if | Inorm(Ω, ϵ) |
| morm(Ω, ϵ) | if | Inorm(Ω, ϵ) ∧ ϵ ∉ dom└−┘_{L}_{₀} |
| | or | Inorm(Ω, ϵ) ∧ load (Ω, └ϵ┘(_{L}_{₀}) = SVsym |
| morm(Ω, [symbol] {e₀, . . . }) | if | ∀i, rnorm(Ω, eᵢ) |
| morm(Ω, {l₁ = e₁, . . . }) | if | ∀i, rnorm(Ω, eᵢ) |
| morm(Ω, ƒ(e₁ . . . eₙ) | if | ƒ is a non-pub0 builtin function |
| | and | ∀i, rnorm (Ω, eᵢ) |

These definitions establish another helpful consequence.

$${〚 e 〛}_{{R}_{0}}^{Ω} = {e}^{′} ⟹ rnorm ( Ω , {e}^{′} ) {and 〚 ϵ 〛}_{{L}_{0}}^{Ω} = {ϵ}^{′} ⟹ Inorm ( Ω , {e}^{′} ) \qquad FACT 4.$$

FACT 5. No pointer dereference will appear in a generated program.

### 10.2 Proof of Theorem 1

Before the proof itself, some simple lemmas about interacting with the actual stack and the symbolic stack are first presented, and then two further lemmas about the correctness of simplifying R-expressions and L-expressions are shown.

$$If {⌊ ϵ ⌋}_{{L}_{0}} = μ , then for any stack Ω , {〚 ϵ 〛}_{L}^{Ω} = μ . \qquad LEMMA 5.$$

The proof follows from structural induction on L-expressions.

$$ℛ ( load ( Ω ) , μ ) = load ( ℛ ( Ω ) , μ ) . \qquad LEMMA 6.$$

$$ℛ ( store ( Ω , μ , v ) ) = store ( ℛ ( Ω ) , μ , ℛ ( v ) ) . \qquad LEMMA 7.$$

$$ℛ ( Ω [ α ↦ v ] ) = ℛ ( Ω ) [ α ↦ ℛ ( v ) ] . \qquad LEMMA 8.$$

$$ℛ ( ω \cdot Ω ) = ℛ ( ω ) \cdot ℛ ( Ω ) . \qquad LEMMA 9.$$

$$load ( Ω , μ ) = v ⟹ {〚 {⌈ ℛ ( v ) , μ ⌉}_{R} 〛}_{R}^{Ω} = v \qquad LEMMA 10.$$

$$If rnorm ℛ ( Ω ) , e ) , then {⌊ e ⌋}_{{R}_{0}} = ℛ ( {〚 ϵ 〛}_{R}^{Ω} ) . \qquad LEMMA 11.$$

$$If Inorm ( ℛ ( Ω ) , ϵ ) , then either ϵ ∉ dom {⌊ - ⌋}_{{L}_{0}} or {⌊ ϵ ⌋}_{{L}_{0}} = {〚 ϵ 〛}_{L}^{Ω} . \qquad LEMMA 12.$$

$${〚 e 〛}_{R}^{Ω} = v ⟹ ∃ {e}^{′} , {〚 e 〛}_{{R}_{0}}^{ℛ ( Ω )} = {e}^{′} ⋀ {〚 {e}^{′} 〛}_{R}^{Ω} = v . \qquad LEMMA 13.$$

$${〚 e 〛}_{L}^{Ω} = μ ⟹ ∃ {ϵ}^{′} , {〚 ϵ 〛}_{{L}_{0}}^{ℛ ( Ω )} = {ϵ}^{′} ⋀ {〚 {ϵ}^{′} 〛}_{L}^{Ω} = μ . \qquad LEMMA 14.$$

The two lemmas can be proven together by structural induction on R-expressions and L-expressions. We discuss a few tricky cases here.

R-expression ϵ. Suppose

$${〚 ϵ 〛}_{R}^{Ω} = v , {〚 ϵ 〛}_{L}^{Ω} = μ$$

and v=load(Ω,μ). Lemma 14 guarantees ϵ can be simplified to ϵ′ where

$${〚 ϵ 〛}_{{L}_{0}}^{ℛ ( Ω )} = {ϵ}^{′} {and 〚 {ϵ}^{′} 〛}_{L}^{Ω} = μ .$$

The goal is to prove there exists an expression e such that

$${〚 ϵ 〛}_{{R}_{0}}^{ℛ ( Ω )} = e {and 〚 e 〛}_{R}^{Ω} = v .$$

Note it is equivalent to prove

$${〚 sload ( ℛ ( Ω ) , {ϵ}^{′} ) 〛}_{R}^{Ω} = v {since 〚 ϵ 〛}_{{R}_{0}}^{ℛ ( Ω )} = sload ( ℛ ( Ω , {〚 ϵ 〛}_{{L}_{0}}^{ℛ ( Ω )} ) = sload ( ℛ ( Ω ) , {ϵ}^{′} ) .$$

There are two cases:
(1) ϵ′∉dome└−┘_{L}_{₀}. Then sload( [symbol] (Ω), ϵ′)=ϵ′. The goal can be proven by

$${〚 {ϵ}^{′} 〛}_{R}^{Ω} = load ( Ω , {〚 {ϵ}^{′} 〛}_{L}^{Ω} ) = load ( Ω , μ ) = v .$$

(2) ϵ′∉dom└−┘_{L}_{₀}. Lemma 5 tells us

$${⌊ {ϵ}^{′} ⌋}_{{L}_{0}} = {〚 {ϵ}^{′} 〛}_{L}^{Ω} = μ .$$

So sload( [symbol] (Ω), ϵ′)=┌load( [symbol] (Ω), μ), μ┐_{R} which equals to ┌ [symbol] (v), μ┐_{R} according to lemma 6. Then the goal can be finished using lemma 10:

$${〚 {⌈ ℛ ( v ) , μ ⌉}_{R} 〛}_{R}^{Ω} = v .$$

R-expression & ϵ. Suppose

$${〚 \& ϵ 〛}_{R}^{Ω} = Vref μ {and 〚 ϵ 〛}_{L}^{Ω} = μ .$$

Lemma 14 shows there exists ϵ′ such that

$${〚 ϵ 〛}_{{L}_{0}}^{ℛ ( Ω )} = {ϵ}^{′} {and 〚 {ϵ}^{′} 〛}_{L}^{Ω} = μ .$$

The goal is to prove

$$\begin{matrix}{〚 \& ϵ 〛}_{{R}_{0}}^{ℛ ( Ω )} = \& {ϵ}^{′} and \\ {〚 \& {ϵ}^{′} 〛}_{R}^{Ω} = Vref μ .\end{matrix}$$

The first goal is direct from the definition. As for the second goal, by definition

$${〚 \& {ϵ}^{′} 〛}_{R}^{Ω} = {Vref 〚 {ϵ}^{′} 〛}_{L}^{Ω} = Vref μ .$$

L-expression ϵ[e] Suppose

$${〚 ϵ [ e ] 〛}_{L}^{Ω} = Vindex μ ℓ n , {〚 ϵ 〛}_{L}^{Ω} = μ , {and 〚 e 〛}_{R}^{Ω} = Vint ℓ n .$$

Lemma 13 and 14 guarantee e and ϵ can be simplified to e′ and ϵ′, respectively, where

$${〚 e 〛}_{{R}_{0}}^{ℛ ( Ω )} = {e}^{′} , {〚 ϵ 〛}_{{L}_{0}}^{ℛ ( Ω )} = {ϵ}^{′} , {〚 {e}^{′} 〛}_{R}^{Ω} = Vint ℓ n , {and 〚 {ϵ}^{′} 〛}_{L}^{Ω} = μ .$$

By definition we know

$${〚 ϵ [ e ] 〛}_{{L}_{0}}^{ℛ ( Ω )} = {ϵ}^{′} [ {e}^{′} ] . {Also 〚 {ϵ}^{′} [ {e}^{′} ] 〛}_{L}^{Ω} = Vindex μ ℓ n .$$

L-expression * e. Suppose

$${〚 * e 〛}_{L}^{Ω} = μ {and 〚 e 〛}_{R}^{Ω} = Vref μ .$$

Lemma 14 shows there exists e′ such that

$${〚 e 〛}_{{R}_{0}}^{ℛ ( Ω )} = {e}^{′} {and 〚 {e}^{′} 〛}_{R}^{Ω} = Vref μ$$

Depending on whether e′ can be simplified or not, there are two cases.
(1) e′=& ϵ for some ϵ. Then

$${〚 * e 〛}_{{L}_{0}}^{ℛ ( Ω )} = ϵ$$

by definition. It is also known

$${〚 ϵ 〛}_{L}^{Ω} = μ$$

because

$${〚 {e}^{′} 〛}_{R}^{Ω} = Vref μ ,$$

so this case is proven.
(2) e′ cannot be simplified. Then

$${〚 * e 〛}_{{L}_{0}}^{ℛ ( Ω )} = * {e}^{′}$$

by definition. Also

$${〚 * e 〛}_{L}^{ℛ ( Ω )} = μ$$

by definition.

Theorem 1 can finally be proven by structural induction on commands.

assert e. Suppose (assert e, Ω)→_{c}(cont, Ω, v) and

$$v = {〚 e 〛}_{R}^{Ω} .$$

Using lemma 13 we know there exists e′ such that

$${〚 e 〛}_{{R}_{0}}^{ℛ ( Ω )} = {e}^{′} {and 〚 {e}^{′} 〛}_{R}^{Ω} = v .$$

The goal is to prove (assert e. [symbol] (Ω)) [symbol] _{c}(cont, [symbol] (Ω), assert e′) and (assert e′,Ω→_{c}(cont, Ω, v). Both goals can be proven using semantics definitions.

x=ƒ(e₁, . . . , eₙ). Suppose (x=ƒ(e₁, . . . , eₙ), Ω)→_{c}(cont, Ω′[a [symbol] v], β), new(x)=a, ƒ [symbol] ( [symbol] τ₁x₁, . . . , τₙxₙ [symbol] [symbol] τ,c)∈Λ^{u}, ∀i∈[1, n],

$${〚 {e}_{i} 〛}_{R}^{Ω} = {v}_{i} ∧ new ( {x}_{i} ) = {a}_{i}$$

and (c, ∪{aᵢ [symbol] vᵢ}·Ω)→_{c}(retv, ω·Ω′, β). For simplicity, let Ω_{c}:=∪{aᵢ [symbol] vᵢ}·Ω. By lemma 13 we know there exists

$${e}_{1}^{′} … {e}_{n}^{′}$$

such that ∀i∈[1,n],

$${〚 {e}_{i} 〛}_{{R}_{0}}^{ℛ ( Ω )} = {e}_{i}^{′} ∧ {〚 {e}_{i}^{′} 〛}_{R}^{Ω} = {v}_{i} .$$

Using lemma 11 we know

$${⌊ {e}_{i}^{′} ⌋}_{{R}_{0}} = ℛ ( {v}_{i} ) .$$

Also lemma 8 shows ∪{aᵢ [symbol] [symbol] (vᵢ)}· [symbol] (Ω)= [symbol] (∪{aᵢ [symbol] vᵢ}·Ω= [symbol] (Ω_{c}). By induction hypothesis we know there exist h and e such that (c, [symbol] (Ω_{c})) [symbol] _{c}(ret e, [symbol] (ω·Ω′), h) and (h, Ω_{c})→_{c}(cont, ω·Ω′, β) and

$${〚 rete 〛}_{\underline{R}}^{ω \cdot {Ω}^{′}} = v .$$

Let h′: push;

$${τ}_{1} {a}_{1} = {e}_{1}^{′} ; … ; {τ}_{n} {a}_{η} = {e}_{n}^{′} ; h ; pop τ a = e ,$$

by semantics' definition we can prove (τx=ƒ(e₁, . . . , eₙ), [symbol] (Ω)) [symbol] _{c}(cont, [symbol] (Ω′)[a [symbol] v],h′) Now we just need to prove (h′, Ω)→_{c}(cont, Ω′[a [symbol] v], β). Note for any j∈[1, i), aⱼ will never appear in eᵢ, so evaluating Ø·Ω is the same as evaluating it after defining x₁, . . . , xᵢ₋₁. So (τ₁x₁=e₁; . . . ; τₙxₙ=eₙ, Ø·Ω)→_{c}(cont, Ω_{c}, [symbol] [symbol] ). The induction hypothesis already shows (h, Ω_{c})→_{c}(cont, ω·Ω′, β). By definition we also know (pop τa=e, ω·Ω′)→_{c}(cont, Ω′[a [symbol] v], [symbol] [symbol] ). We can prove the goal by concatenating these commands together.

τx=e. Suppose (τx=e, Ω)→_{c}(cont, Ω[a [symbol] v], [symbol] [symbol] ), new(x)=a, and

$$v = {〚 e 〛}_{R}^{Ω} .$$

Lemma 13 guarantees there exists e′ such that

$${〚 e 〛}_{{R}_{0}}^{ℛ ( Ω )} = {e}^{′} {and 〚 {e}^{′} 〛}_{R}^{Ω} = v .$$

By definition we know (τx=e, [symbol] (Ω)) [symbol] _{c}(cont, [symbol] (Ω)[a [symbol] └e′┘_{R}_{₀}], τa=e′). So we only need to prove [symbol] (Ω)[a [symbol] └e′┘_{R}_{₀}] and (τa=e′, Ω)→_{c}(cont, Ω[a [symbol] v], [symbol] [symbol] ). The second one is direct from the definition. As for the first one, by lemma 11 we know └e′┘_{R}_{₀}= [symbol] (v), so [symbol] (Ω)[a [symbol] └e′┘_{R}_{₀}]= [symbol] (Ω)[a [symbol] [symbol] (v)] which is equal to [symbol] (Ω[a [symbol] v]) by lemna 8.

ϵ=e. Suppose (ϵ=e, Ω)→_{c}(cont, store(Ω, μ, v), [symbol] [symbol] ),

$${〚 e 〛}_{R}^{Ω} = v , {and 〚 e 〛}_{L}^{Ω} = μ .$$

Lemma 13 and 14 show there exists e′ and ϵ′ such that

$${〚 e 〛}_{{R}_{0}}^{ℛ ( Ω )} = {e}^{′} , {〚 e 〛}_{{L}_{0}}^{ℛ ( Ω )} = {ϵ}^{′} , {〚 {e}^{′} 〛}_{R}^{Ω} = μ , {and 〚 {ϵ}^{′} 〛}_{L}^{Ω} = μ .$$

By definition we already know (ϵ′=e′, Ω)→_{c}(cont, store(Ω,μ,v), [symbol] [symbol] ) and (ϵ=e, [symbol] (Ω) [symbol] _{c}(cont, sstore( [symbol] (Ω), ϵ′, e′), ϵ′=e′) so we only need to prove sstore( [symbol] (Ω), ϵ′, e′)= [symbol] (store(Ω, μ, v)). Depending on whether ϵ′ can be fully evaluated or not, there are two cases.
(1) If ϵ′∉dom└−┘_{L}_{₀}, then sstore( [symbol] (Ω), ϵ′, e′)= [symbol] (Ω) also/has non-pub0 information, so the type well formedness guarantees the value pointed by it can not contain any pub0. So we know [symbol] (v) is full of SVsym, so

$$ℛ ( store ( Ω , μ , v ) ) = ℛ ( Ω ) .$$

(2) If ϵ′∈dom└−┘_{L}_{₀}, then lemma 12 tells us └ϵ′┘_{L}_{₀}=μ. Also lemnma 11 tells us └e′┘_{R}_{₀}= [symbol] (v). So sstore ( [symbol] (Ω), ϵ′, e′)=store ( [symbol] (Ω,μ, [symbol] (μ)) which equals to [symbol] (store(Ω,μ,v)) by lemma 7.

Termination. Technically, we cannot do structural induction on while loops as they may not terminate But since in the hypothesis the command terminates with r and β, we can always find a ranking function on stacks that reduces as the program executes.

### 11. Appendix D—Detailed Live Variable Analysis

Recall that └−┘_{L}_{₀} is a partial function as it may fail when the L-expression refers to an array index with a non-K₀ access level. We can, however, define a total function

$${⌊ ϵ ⌋}_{{L}_{0}}^{*}$$

to compute the smallest L-value with K₀ access level that includes the result of ϵ.

$${⌊ α ⌋}_{{L}_{0}}^{*} = Vvar a$$

$${⌊ ϵ [ e ] ⌋}_{{L}_{0}}^{*} = \{ \begin{matrix}μ & if {⌊ ϵ [ e ] ⌋}_{{L}_{0}} = μ \\ {⌊ ϵ ⌋}_{{L}_{0}}^{*} & otherwise\end{matrix}$$

$${⌊ ϵ \cdot l ⌋}_{{L}_{0}}^{*} = \{ \begin{matrix}μ & if {⌊ ϵ \cdot l ⌋}_{{L}_{0}} = μ \\ {⌊ ϵ ⌋}_{{L}_{0}}^{*} & otherwise\end{matrix}$$

Due to Fact 5 we can ignore dereferencing pointers. Let the set prims(μ) contain all smallest L-values with K₀ access level that reside in μ. We use prims(μ) to define two functions Lread(ϵ) and Rread(e) that collect all of the smallest K₀ L-values from ϵ and e's subexpressions, respectively. We also define Pointed(e) to collect all of the smallest L-values with K₀ access level that are pointed to by e's subexpressions. It is used to analyze a sandboxed function's arguments, as every pointer passed into a sandboxed function is potentially read. We omit its definition as it is near identical to Rread(e) itself

```
    Lread(a) = ∅
    Lread(ϵ[e]) = Lread(ϵ) ∪ Rread(e)
    Lread(ϵ, l) = Lread(ϵ)
    Rread( [symbol]   n) = ∅
    Rread(& e) = ∅
    $Rread ( ϵ ) = prims ( {⌊ ϵ ⌋}_{{L}_{0}}^{*} ) ⋃ Lread ( ϵ )$
    Rread(f(e₁, ... )) = U(Rread(eᵢ)
    Rread( [symbol] (e₁, ... )) = U(Rread(eᵢ)
REF(τ α = e) = Rread(e)
REF(τ α = f(e₁, ... )) = U(Rread(eᵢ) ∪ Pointed(eᵢ)
REF(τ α = f(e₁, ... )RS_{R}WS_{W}) = U(Rread(eᵢ) ∪ S_{R}
REF(assert e) = Rread(e)
REF(ϵ = e) = Lread(ϵ) ∪ Rread(e)
DEF(τ α = e) = prism(Vvar α)
DEF(τ α = f(e₁, ... )) = prism(Vvar α) ∪ UPointed(eᵢ)
DEF(τ α = f(e₁, ... )RS_{R}WS_{W}) = prism(Vvar α) ∪ S_{W}
DEF(assert e) = ∅
$DEF ( ϵ = e ) = prism ( Vvar {⌊ ϵ ⌋}_{{L}_{0}}^{*} )$
```

Some simple facts about the ≈ relation.

$$FACT 6. Ω {\approx }_{{S}_{1}} {Ω}^{′} ∧ Ω {\approx }_{{S}_{2}} {Ω}^{′} ⇒ Ω {\approx }_{{S}_{1} ⋃ {S}_{2}} {Ω}^{′} .$$

$$FACT 7. Ω {\approx }_{S} {Ω}_{1} ∧ {Ω}_{1} {\approx }_{S} {Ω}_{2} ⇒ Ω {\approx }_{S} {Ω}_{2} .$$

$$FACT 8. Ω {\approx }_{{S}_{1}} {Ω}^{′} ∧ {S}_{2} ⊆ {S}_{1} ⇒ Ω {\approx }_{{S}_{2}} {Ω}^{′} .$$

In Theorem 2's setting, Some dependencies may go over c j, i.e., a command after c j may depend on a command before c j. This theorem shows c j does not touch such values.

Theorem 15. Using Theorem 2's setting, if μ∈DEP(i, k) where i<j<k, then

$$∀ {Ω}_{j - 1} , {Ω}_{j - 1} {\approx }_{DEP ( - , j ) ⋃ \{ μ \}} {Ω}_{j - 1} ⇒$$

$$∀ {Ω}_{j}^{′} , ( {c}_{j} , {Ω}_{j - 1}^{′} ) {\to }_{C} ( cont , {Ω}_{j}^{′} , β ) , load ( {Ω}_{j - 1}^{′} ) = load ( {Ω}_{j}^{′} )$$

11.1 Compromise in analysis

Note this section's discussion assumes the reader has read Sec. 5.2 One part of the optimal cutting problem's goal is to minimize the sum of all chunk's external dependencies. However, in many cases, the cutting cost could be smaller. Consider

| | |
|---|---|
| 1 | pvt int x = . . . ; |
| 2 | pvt int y = x ; |
| 3 | pvt int z = x ; |

Suppose the cutting cost of one pvt int value is N. If DZKP decides to partition L1 into one chunk, L2 and L3 into another chunk, then the OPB's encoding considers the cutting cost to be 2N. However, since x is not updated between L2 and L3, L3 can use x's local value without synchronization.

We could have used a more accurate encoding, but that will significantly increase the complexity and slow down the solver. So here we make a compromise by moving the dependency between L1 and L3 to L2 and L3. Now the dependency becomes local, so it no longer contributes to the total cutting cost.

We can rigorously prove in most cases, this approach does not reduce the total cutting cost in the encoding: If the program is cut into ( [symbol] 1 [symbol] , [symbol] 2, 3 [symbol] ), ( [symbol] 1, 2 [symbol] , [symbol] 3 [symbol] ) or ( [symbol] 1 [symbol] , [symbol] 2 [symbol] , [symbol] 3 [symbol] ), the total cost does not change (even if there are other commands involved), here is only one case that results in bigger cutting cost: ( [symbol] 1, 3 [symbol] , [symbol] 2 [symbol] ). In other words, we will overestimate the total cost. This may not be a bad thing as now our encoding is prone to cut the program without breaking its original structure. Also, if the program has better performance by cutting 2 out, then usually the user can rewrite the program by moving commands that have close data dependencies together.

### 12. Appendix E—Detailed Deep Simulation

Here are some unlisted semantics rules.

$$dload ( Ω , ϵ ) = \{ \begin{matrix}{⌈ load ( Ω , μ ) , μ ⌉}_{R} & when {⌊ ϵ ⌋}_{{L}_{1}} = μ \\ ϵ & otherwise\end{matrix}$$

$$dstore ( Ω , ϵ , e ) = \{ \begin{matrix}store ( Ω , μ , {⌊ e ⌋}_{{R}_{1}} & when {⌊ ϵ ⌋}_{{L}_{1}} = μ \\ Ω & otherwise\end{matrix}$$

$${〚 x 〛}_{{L}_{1}}^{Ω} = find ( Ω , r )$$

$${〚 ϵ [ e ] 〛}_{{L}_{1}}^{Ω} = {〚 ϵ 〛}_{{L}_{1}}^{Ω} [ {〚 e 〛}_{{R}_{1}}^{Ω} ]$$

$${〚 ϵ \cdot l 〛}_{{L}_{1}}^{Ω} = {〚 ϵ 〛}_{{L}_{1}}^{Ω} \cdot l$$

$${〚 * e 〛}_{{L}_{1}}^{Ω} = ϵ {when 〚 e 〛}_{{R}_{1}}^{Ω} = \& ϵ$$

$${〚 ϵ 〛}_{{R}_{1}}^{Ω} = dload ( Ω , {〚 ϵ 〛}_{{L}_{1}}^{Ω} )$$

$${〚 \& ϵ 〛}_{{R}_{1}}^{Ω} = \& {〚 ϵ 〛}_{{L}_{1}}^{Ω}$$

$${〚 ℓ \{ {e}_{0} , … , {e}_{n - 1} \} 〛}_{{R}_{1}}^{Ω} = ℓ \{ {〚 {e}_{0} 〛}_{{R}_{1}}^{Ω} , … , {〚 {e}_{n - 1} 〛}_{{R}_{1}}^{Ω} \}$$

$${〚 𝔣 ( {e}_{1} , … , {e}_{n} ) 〛}_{{R}_{1}}^{Ω} = \{ \begin{matrix}{( \vert 𝔣 \vert )}_{1} ( {〚 {e}_{1} 〛}_{{R}_{1}}^{Ω} , … , {〚 {e}_{n} 〛}_{{R}_{1}}^{Ω} ) & when 𝔣 ∈ dom {( \vert - \vert )}_{0} \\ 𝔣 ( {〚 {e}_{1} 〛}_{{R}_{1}}^{Ω} , … , {〚 {e}_{n} 〛}_{{R}_{1}}^{Ω} ) & otherwise\end{matrix}$$

$$\frac{new ( x ) = {α 〚 e 〛}_{{R}_{1}}^{Ω} = {e}^{′}}{( τ x = e , Ω ) {\text{?}}_{C} ( cont , Ω [ α ↦ {⌊ e ⌋}_{{R}_{0}} ] )}$$

$$\frac{{〚 ϵ 〛}_{{L}_{1}}^{Ω} = {{ϵ}^{′} 〚 e 〛}_{{R}_{1}}^{Ω} = {e}^{′}}{( ϵ = e , Ω ) {\text{?}}_{C} ( cont , dstore ( Ω , {ϵ}^{′} , {e}^{′} ) )}$$

$$\overline{( return e , Ω ) {\text{?}}_{C} ( {ret 〚 e 〛}_{{R}_{1}}^{Ω} , Ω )}$$

$$\overline{( assert e , Ω ) {\text{?}}_{C} ( cont , Ω )}$$

$$\frac{( {c}_{1} , Ω ) {\text{?}}_{C} ( ret e , {Ω}_{1} )}{( {c}_{1} ; {c}_{2} , Ω ) {\text{?}}_{C} ( ret e , {Ω}_{1} )}$$

$$\frac{( {c}_{1} , Ω ) {\text{?}}_{C} ( cont , {Ω}_{1} ) ( {c}_{2} , {Ω}_{1} ) {\text{?}}_{C} ( r , {Ω}_{2} )}{( {c}_{1} ; {c}_{2} , Ω ) {\text{?}}_{C} ( ret e , {Ω}_{1} )}$$

$$\frac{{〚 e 〛}_{{R}_{1}}^{Ω} = ℓ true ( {c}_{1} , Ω ) {\text{?}}_{C} ( r , {Ω}^{′} )}{( if e then {c}_{1} else {c}_{2} , Ω ) {\text{?}}_{C} ( r , {Ω}^{′} )}$$

$$\frac{{〚 e 〛}_{{R}_{1}}^{Ω} = ℓ false ( {c}_{2} , Ω ) {\text{?}}_{C} ( r , {Ω}^{′} )}{( if e then {c}_{1} else {c}_{2} , Ω ) {\text{?}}_{C} ( r , {Ω}^{′} )}$$

$${〚 e 〛}_{{R}_{1}}^{Ω} = ℓ true$$

$$\frac{( c ; while e do c , Ω ) {\text{?}}_{C} ( r , {Ω}^{′} )}{( while e do c , Ω ) {\text{?}}_{C} ( r , {Ω}^{′} )}$$

$$\frac{{〚 e 〛}_{{R}_{1}}^{Ω} = ℓ false}{( while e do c , Ω ) {\text{?}}_{C} ( cont , Ω )}$$

$$new ( x ) = α η ∈ \{ normal , atomic , plocal 1 , box 1 \}$$

$$f ↦ internal ( η , ( {τ}_{1} {x}_{1} , … , {τ}_{n} {x}_{n} ) \to τ , c ) ∈ {Λ}^{u}$$

$$∀ i ∈ [ 1 , n ] , {〚 {e}_{i} 〛}_{{R}_{1}}^{Ω} = {e}_{i}^{′} ∧ new ( {x}_{i} ) = {α}_{i}$$

$$\frac{( c , ⋃ \{ {α}_{i} ↦ {⌊ {e}_{i}^{′} ⌋}_{{R}_{1}} \} \cdot Ω ) {\text{?}}_{C} ( ret e , ω \cdot {Ω}^{′} )}{( τ x = f ( {e}_{1} , … , {e}_{n} ) , Ω ) {\text{?}}_{C} ( cont , {Ω}^{′} [ α ↦ {⌊ e ⌋}_{{R}_{1}} ] )}$$

$$new ( x ) = α η ∈ \{ plocal 2 , box 2 \}$$

$$f ↦ internal ( η , ( {τ}_{1} {x}_{1} , … , {τ}_{n} {x}_{n} ) \to τ , c ) ∈ {Λ}^{u}$$

$$\frac{∀ i ∈ [ 1 , n ] , {〚 {e}^{′} 〛}_{{R}_{1}}^{Ω} = {e}_{i}^{′}}{( τ x = f ( {e}_{1} , … , {e}_{n} ) , Ω ) {\text{?}}_{C} ( cont , Ω )}$$

$$LEMMA {16. 〚 e 〛}_{R}^{Ω} = v ⟹ ∃ {e}^{′} , {〚 e 〛}_{{R}_{1}}^{𝒬 ( Ω )} = {e}^{′} ∧ {〚 {e}^{′} 〛}_{R}^{Ω} = v$$

$$LEMMA {17. 〚 ϵ 〛}_{L}^{Ω} = μ ⟹ ∃ {ϵ}^{′} , {〚 ϵ 〛}_{{L}_{1}}^{𝒬 ( Ω )} = {ϵ}^{′} ∧ {〚 {ϵ}^{′} 〛}_{R}^{Ω} = μ$$

### 13. Appendix F—Distribution Proofs

We denote chunk⁻¹(t):={i|chunk(i)=t}. We let

$${ϕ}_{j}^{t}$$

be the set of L-values that are used in [1,j]∩chunk⁻¹(t) and needed in {j+1,n}∪chunk⁻¹(t).

$${ϕ}_{j}^{t} := {{{⋃}_{i \leq j \leq k}}_{chunk ( i ) = t}}_{chunk ( k ) = t} DEP ( i , k )$$

Theorem 4 can be derived from the following lemma.

LEMMA 18. ∀j∈chunk⁻¹(t)

$${Ω}_{j}^{pre} {\approx }_{S} {Ω}_{j - 1}$$

where

$$S = {ϕ}_{j - 1}^{t} ⋃ DEP ( - , j )$$

We prove it together with the following lemma by induction on the sequential program.

LEMMA 18. ∀j∈[1, n],

$${Ω}_{j - 1}^{post} {\approx }_{S} {Ω}_{j}$$

where

$$S = {ϕ}_{j}^{t} .$$

Subgoal 1. Suppose chunk(j)=t and

$${Ω}_{j - 1}^{post} {\approx }_{S} {Ω}_{j - 1}$$

$$where$$

$$S = {ϕ}_{j}^{t} .$$

we want to derive

$${Ω}_{j}^{pre} {\approx }_{{s}^{′}} {Ω}_{j - 1}$$

$$where$$

$${S}^{′} = {ϕ}_{j - 1}^{t} ⋃ DEP ( j , - 1 ) .$$

We know

$${Ω}_{j - 1}^{post} {\approx }_{S} {Ω}_{j}^{pre}$$

as syncⱼ only updates external dependencies, so fact 7 ensures

$${Ω}_{j}^{pre} {\approx }_{S} {Ω}_{j - 1} .$$

Also, theorem 3 guarantees the correctness of syncⱼ, i.e.,

$${Ω}_{j}^{pre} {\approx }_{{S}^{″}} {Ω}_{j - 1}$$

$$where$$

$${S}^{″} = {⋃}_{chunk ( i ) \neq t} DEP ( i , j ) .$$

Finally, we can prove

$${ϕ}_{j - 1}^{t} {⋃}_{chunk ( i ) \neq t} DEP ( i , j ) ⊆ {ϕ}_{j - 1}^{t} ⋃ DEP ( - , j )$$

then use fact 6 and 8 to derive

$${Ω}_{j}^{pre} {\approx }_{{S}^{′}} {Ω}_{j - 1} .$$

Subgoal 2. Suppose chunk(j)=t and

$${Ω}_{j}^{pre} {\approx }_{{s}^{′}} {Ω}_{j - 1}$$

$$where$$

$${S}^{′} = {ϕ}_{j - 1}^{t} ⋃ DEP ( - , j ) ,$$

we want to derive

$${Ω}_{j}^{post} {\approx }_{S} {Ω}_{j}$$

$$where$$

$$S = {ϕ}_{j}^{t} .$$

We divide

$${ϕ}_{j}^{t}$$

into two parts S₁ and S₂ where S₁=∪_{chunk(k)=t}DEP(j, k) contains all internal dependencies coming out of j, and

$${S}_{2} = {ϕ}_{j}^{t} - {S}_{1}$$

contains internal dependencies coming before j. Theorem 2 ensures

$${Ω}_{j}^{post} {\approx }_{{S}_{1}} {Ω}_{j} ,$$

and theorem 15 ensures Ωⱼ₋₁≈s₂Ωⱼ and

$${Ω}_{j}^{post} {\approx }_{{S}_{2}} {Ω}_{j}^{post} .$$

### Notice

$${S}_{2} ⊆ {ϕ}_{j - 1}^{t} ,$$

so we can combine with the hypothesis to derive

$${Ω}_{j}^{post} {\approx }_{S} {Ω}_{j} .$$

Finally, we can use fact 6 to derive the goal.

The disclosures of each and every patent, patent application, and publication cited herein are hereby incorporated herein by reference in their entirety.

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1. A method of parallelizing zero-knowledge (ZK) protocols, the method comprising:
providing a ZK framework;
calculating local and communication costs for each program instruction of a ZK statement;
automatically partitioning the ZK statement according to the calculation; and
distributing the partitioned ZK statement to a corresponding number of computing cores for parallel proving or verification.

2. The method of claim 1, wherein the calculating includes determining sums of the maximum per-machine cost and cumulative communication costs.

3. The method of claim 2, wherein the partitioning of the ZK statement includes chunking the ZK statement to provide a lowest or substantially lowest sum of the maximum per-machine cost and cumulative communication costs based upon the calculation.

4. The method of claim 1, wherein the partitioning of the ZK statement is arbitrary.

5. The method of claim 4, wherein the ZK framework permits proving multiple statements of a single witness while ensuring consistency.

6. The method of claim 5, wherein the framework is configured to execute a commit-and-prove paradigm.

7. The method of claim 6, further comprising:
a prover committing private inputs; and
constructing a proof establishing some public relationship among the committed values;
wherein the public relationship among the committed values is established without revealing the committed values to a verifier.

8. The method of claim 7, further comprising establishing multiple statements on the private inputs.

9. The method of claim 1, wherein the partitioning comprises forming at least two substatements.

10. The method of claim 9, further comprising precomputing the input/output of each substatement.

11. The method of claim 10, wherein precomputing comprises forming an extended witness, the extended witness resolving data dependency.

12. The method of claim 1, wherein the partitioning comprises shallow simulation and deep simulation.

13. The method of claim 12, wherein the shallow simulation comprises:
the automatic partitioning of the ZK statement; and
selecting of variables as witnesses for each substatement.

14. The method of claim 13, wherein the shallow simulation comprises:
computing the costs of each instruction in the ZK statement using live variable analysis; and
modeling the computed costs as a directed acyclic graph for partitioning.

15. The method of claim 14, wherein the partitioning comprises pseudo-Boolean optimization (PBO) or integer linear programming (ILP).

16. The method of claim 13, wherein the deep simulation comprises:
computing extended witness values using a prover's private inputs; and
computing public variable values.

17. The method of claim 16, wherein the computing of the extended witness values and public variable values comprises propagating input-dependent values through the ZK statement.

18. The method of claim 1, wherein the framework comprises annotation tools configured to identify knowledge levels.

19. The method of claim 18, wherein the knowledge levels comprises private input-independent values known at compile time, private input-dependent values that are known at distribution time, and variables that are only known at runtime.

20. The method of claim 19, wherein the private input-independent values and the private input-dependent values are allowed to flow into the variables that are only known at runtime, but the variables that are only known at runtime are not allowed to flow into the private input-independent values and the private input-dependent values.

21. The method of claim 20, wherein the partitioning step includes treating the variables that are only known at runtime as a single contiguous block to estimate worth-case cost and enforce sequential ordering.

22. The method of claim 1, wherein the distributed ZK statement includes randomized verification.

23. An apparatus for parallelizing zero-knowledge (ZK) protocols, the apparatus comprising:
a processor;
a memory unit; and
a communication interface;
wherein the processor is connected to the memory unit and the communication interface; and
wherein the processor and memory are configured to implement the method of claim 1.

24. An apparatus for proving zero-knowledge (ZK) protocols, the apparatus comprising:
at least two processors;
a memory unit; and
a communication interface;
wherein the processors are connected to the memory unit and the communication interface; and
wherein a ZK statement parallelized according to the method of claim 1 is distributed among the at least two processors.

25. A non-transitory computer readable storage medium storing computer-executable instructions for performing the method of claim 1.
